(19) United States
(12) Patent Application Publication
(10) Pub. No.: US 2023/0023885 A1
(43) Pub. Date: Jan. 26, 2023

(54) OPHTHALMIC DEVICES DERIVED FROM GRAFTED POLYMERIC NETWORKS AND PROCESSES FOR THEIR PREPARATION AND USE

(71) Applicant: Johnson & Johnson Vision Care, Inc., Jacksonville, FL (US)

(72) Inventors: Michael J. Lopez, Jacksonville, FL (US); James D. Ford, Fleming Island, FL (US); Shivkumar Mahadevan, Jacksonville, FL (US); Stephanie Sheridan, Jacksonville, FL (US); Alejandra Isabel Garcia, Jacksonville, FL (US)

(21) Appl. No.: 17/662,916

(22) Filed: May 11, 2022

Related U.S. Application Data
(60) Provisional application No. 63/216,586, filed on Jun. 30, 2021.

(51) Int. Cl. B29D 11/00; C08F 220/10; C08F 220/54; C08F 222/10; C08F 290/06; C08G 18/04; C08G 18/61; C08G 18/62

(52) U.S. Cl. CPC B29D 11/00067; B29D 11/00076; C08F 220/10; C08F 220/54; C08F 222/102; C08F 290/068; C08G 18/04; C08G 18/61; C08G 18/6225; C08G 2270/00

(57) ABSTRACT

Provided is a process for making an ophthalmic devices and ophthalmic devices resulting from the process. The process comprises: (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker; (b) subjecting the first reactive composition to a first activation step such that the first reactive composition polymerizes therein to form a crosslinked substrate network containing a covalently bound activatable free radical initiator; (c) contacting the crosslinked substrate network with a grafting composition containing a shrinking agent and one or more ethylenically unsaturated compounds; and (d) activating the covalently bound activatable free radical initiator of the crosslinked substrate network such that the grafting composition polymerizes therein with the crosslinked substrate network.

### RELATED APPLICATIONS

This application claims priority to U.S. Provisional Patent Application Ser. No. 63/216,586, filed Jun. 30, 2021, which is incorporated herein by reference in its entirety.

### FIELD OF THE INVENTION

The invention relates to ophthalmic devices, such as contact lenses, that contain grafted polymeric networks and processes for preparing and using the ophthalmic devices.

### BACKGROUND OF THE INVENTION

The development of polymer materials prepared from individual components that contribute desirable properties is an ongoing goal in many product areas. For instance, polymer materials displaying oxygen permeability and hydrophilicity are desirable for a number of applications within the medical devices field, such as in ophthalmic devices.

A commonly encountered challenge when forming polymeric materials that attempt to combine properties is that in many cases, the individual components from which the final material is made are not readily compatible. For instance, in the contact lens field, silicone hydrogels have been found to provide lenses with significantly increased oxygen permeability and therefore are capable of reducing corneal edema and hyper-vasculature, conditions that may sometimes be associated with conventional hydrogel lenses. Silicone hydrogels have typically been prepared by polymerizing mixtures containing at least one silicone-containing monomer or reactive macromer and at least one hydrophilic monomer. However, silicone hydrogel lenses can be difficult to produce because the silicone components and the hydrophilic components are often incompatible.

New technologies for creating polymer materials are desirable in many fields, including ophthalmic devices.

### SUMMARY OF THE INVENTION

The invention relates to polymeric compositions, and processes for their preparation, derived from a wide variety of component monomers and polymers, including where such component monomers and polymers are generally incompatible. Polymeric compositions of the invention find use in various applications, for instance in ophthalmic devices.

Thus, the invention provides a process for making an ophthalmic device, the process comprising: (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker; (b) subjecting the first reactive composition to a first activation step such that the first reactive composition polymerizes therein to form a crosslinked substrate network containing a covalently bound activatable free radical initiator; (c) contacting the crosslinked substrate network with a grafting composition containing a shrinking agent and one or more ethylenically unsaturated compounds; and (d) activating the covalently bound activatable free radical initiator of the crosslinked substrate network such that the grafting composition polymerizes therein with the crosslinked substrate network.

The invention also provides an ophthalmic device made by the process described herein.

### BRIEF DESCRIPTION OF THE FIGURES

FIG. 1 shows lens shrinkage with salt solutions of mPEG500.

FIG. 2 shows the concentration of mPEG500 grafted on the surface of Example 1 Lenses.

FIG. 3 shows the concentration of mPEG500 grafted on the surface of Example 2 Lenses.

FIG. 4 shows the concentration of mPEG500 grafted on the surface of Example 3 Lenses.

FIG. 5 shows the concentration of mPEG500 grafted on the surface of Example 4 Lenses.

FIG. 6 shows the concentration of mPEG500 grafted on the surface of Example 5 Lenses.

FIG. 7 shows the concentration of mPEG500 grafted on the surface of Example 6 Lenses.

FIG. 8 shows the concentration of mPEG500 grafted on the surface of Example 7 Lenses.

FIG. 9 shows the concentration of mPEG500 grafted on the surface of Example 8 Lenses.

FIG. 10 shows the concentration of mPEG500 grafted on the surface of Example 9 Lenses.

FIG. 11 shows the concentration of MPC grafted on the surface of Example 9 Lenses.

FIG. 12 shows the PVP/methacrylate band ratio consistent with HEMA grafting on the surface of Example 9 Lenses.

FIG. 13 shows the DMA/methacrylate band ratio consistent with HEMA grafting on the surface of Example 9 Lenses.

FIG. 14 shows the silicone/methacrylate band ratio consistent with HEMA grafting on the surface of Example 9 Lenses.

FIG. 15 shows the PEG/methacrylate band ratio consistent with mPEG500 grafting on the surface of Example 10 Lenses.

FIG. 16 shows the DMA/methacrylate band ratio consistent with DMA grafting on the surface of Example 10 Lenses.

FIG. 17 shows weight percent of grafted PEG on the front curves (FC) and base curves (BC) of Example 11 Lenses.

FIG. 18 shows weight percent of grafted PEG on the front curves (FC) and base curves (BC) of Example 12 Lenses.

### DETAILED DESCRIPTION OF THE INVENTION

As noted above, the invention relates to a grafting process and to products prepared by such process. Among the features of the invention is the discovery that the inclusion of compounds such as alkali metal salts in a composition being grafted onto a substrate results in shrinkage of the substrate. This shrinkage collapses the substrate, thus limiting the diffusion of ethylenically unsaturated compounds into the bulk of the substrate and consequently resulting in preferential surface functionalization during the grafting step. Additionally, the shrinking agent aids in facilitating the grafting process.

With respect to the terms used in this disclosure, the following definitions are provided.

Unless defined otherwise, all technical and scientific terms used herein have the same meaning as commonly understood by one of ordinary skill in the art to which the invention belongs. All publications, patent applications, patents, and other references mentioned herein are incorporated by reference.

Unless otherwise indicated, numeric ranges, for instance as in “from 2 to 10” or as in “between 2 and 10” are inclusive of the numbers defining the range (e.g., 2 and 10). Unless otherwise indicated, ratios, percentages, parts, and the like are by weight.

The phrase “number average molecular weight” refers to the number average molecular weight (Mₙ) of a sample; the phrase “weight average molecular weight” refers to the weight average molecular weight (M_{w}) of a sample; the phrase “polydispersity index” (PDI) refers to the ratio of M_{w} divided by Mₙ and describes the molecular weight distribution of a sample. If the type of “molecular weight” is not indicated or is not apparent from the context, then it is intended to refer to number average molecular weight.

As used herein, the term “about” refers to a range of +/−10 percent of the number that is being modified. For example, the phrase “about 10” would include both 9 and 11.

As used herein, the term “(meth)” designates optional methyl substitution. Thus, a term such as “(meth)acrylate” denotes both methacrylate and acrylate.

Wherever chemical structures are given, it should be appreciated that alternatives disclosed for the substituents on the structure may be combined in any combination. Thus, if a structure contained substituents R* and R**, each of which contained three lists of potential groups, 9 combinations are disclosed. The same applies for combinations of properties.

The average number of repeating units in a polymer sample is known as its “degree of polymerization.” When a generic chemical formula of a polymer sample, such as [***]n is used, “n” refers to its degree of polymerization, and the formula shall be interpreted to represent the number average molecular weight of the polymer sample.

As used herein, the term “individual” includes humans and vertebrates.

As used herein, the term “ophthalmic device” refers to any device which resides in or on the eye or any part of the eye, including the ocular surface. These devices can provide optical correction, cosmetic enhancement, vision enhancement, therapeutic benefit (for example as bandages) or delivery of active components such as pharmaceutical and nutraceutical components, or a combination of any of the foregoing. Examples of ophthalmic devices include but are not limited to lenses, optical and ocular inserts, including but not limited to punctal plugs, and the like. “Lenses” include soft contact lenses, hard contact lenses, hybrid contact lenses, intraocular lenses, and inlay and overlay lenses. The ophthalmic device preferably may comprise a contact lens.

As used herein, the term “contact lens” refers to an ophthalmic device that can be placed on the cornea of an individual's eye. The contact lens may provide corrective, cosmetic, or therapeutic benefit, including wound healing, the delivery of drugs or nutraceuticals, diagnostic evaluation or monitoring, ultraviolet light blocking, visible light or glare reduction, or any combination thereof. A contact lens can be of any appropriate material known in the art and can be a soft lens, a hard lens, or a hybrid lens containing at least two distinct portions with different physical, mechanical, or optical properties, such as modulus, water content, light transmission, or combinations thereof.

The ophthalmic devices and contact lenses of the invention may be comprised of silicone hydrogels. These silicone hydrogels typically contain at least one hydrophilic monomer and at least one silicone-containing component that are covalently bound to one another in the cured device. The ophthalmic devices and contact lenses of the invention may also be comprised of conventional hydrogels, or combination of conventional and silicone hydrogels.

A “macromolecule” is an organic compound having a number average molecular weight of greater than 1500, and may be reactive or non-reactive.

As used herein, the “target macromolecule” is the intended macromolecule being synthesized from the reactive composition comprising monomers, macromers, prepolymers, cross-linkers, initiators, additives, diluents, and the like.

As used herein, a “monomer” is a mono-functional molecule which can undergo chain growth polymerization, and in particular, free radical polymerization, thereby creating a repeating unit in the chemical structure of the target macromolecule. Some monomers have di-functional impurities that can act as cross-linking agents. A “hydrophilic monomer” is also a monomer which yields a clear single phase solution when mixed with deionized water at 25° C. at a concentration of 5 weight percent. A “hydrophilic component” is a monomer, macromer, prepolymer, initiator, cross-linker, additive, or polymer which yields a clear single phase solution when mixed with deionized water at 25° C. at a concentration of 5 weight percent.

As used herein, a “macromonomer” or “macromer” is a linear or branched macromolecule having at least one polymerizable group that can undergo chain growth polymerization, and in particular, free radical polymerization.

As used herein, the term “polymerizable” means that the compound comprises at least one polymerizable group. “Polymerizable groups” are groups that can undergo chain growth polymerization, such as free radical and/or cationic polymerization, for example a carbon-carbon double bond group which can polymerize when subjected to radical polymerization initiation conditions. Non-limiting examples of polymerizable groups include (meth)acrylates, styrenes, vinyl ethers, (meth)acrylamides, N-vinyllactams, N-vinylamides, O-vinylcarbamates, O-vinylcarbonates, and other vinyl groups. Preferably, the polymerizable groups comprise (meth)acrylates, (meth)acrylamides, and mixtures thereof. Preferably, the polymerizable groups comprise (meth)acrylate, (meth)acrylamide, N-vinyl lactam, N-vinylamide, styryl functional groups, or mixtures of any of the foregoing. The polymerizable group may be unsubstituted or substituted. For instance, the nitrogen atom in (meth)acrylamide may be bonded to a hydrogen, or the hydrogen may be replaced with alkyl or cycloalkyl (which themselves may be further substituted). In contrast to “polymerizable,” the term “non-polymerizable” means that the compound does not comprise such a free radical polymerizable group.

Examples of the foregoing include substituted or unsubstituted C₁₋₆alkyl(meth)acrylates, C₁₋₆alkyl(meth)acrylamides, C₂₋₁₂alkenyls, C₂₋₁₂alkenylphenyls, C₂₋₁₂alkenylnaphthyls, C₂₋₆alkenylphenylC₁₋₆alkyls, where suitable substituents on said C₁₋₆ alkyls include ethers, hydroxyls, carboxyls, halogens and combinations thereof.

Any type of free radical polymerization may be used including but not limited to bulk, solution, suspension, and emulsion as well as any of the controlled radical polymerization methods such as stable free radical polymerization, nitroxide-mediated living polymerization, atom transfer radical polymerization, reversible addition fragmentation chain transfer polymerization, organotellurium mediated living radical polymerization, and the like.

An “ethylenically unsaturated compound” is a monomer, macromer, or prepolymer that contains at least one polymerizable group. An ethylenically unsaturated compound may preferably consist of one polymerizable group.

“Shrinking agent” refers to a material that is capable of causing a reduction in the physical size of the crosslinked substrate network. For instance, if the crosslinked substrate network is in the shape of a contact lens, the diameter of the lens will be reduced following its exposure to the shrinking agent. Determining a material's ability to function as a shrinking agent, including the applicable concentration of the agent, is straightforward and is demonstrated, for instance, by the Examples below.

As used herein, a “silicone-containing component” or “silicone component” is a monomer, macromer, prepolymer, cross-linker, initiator, additive, or polymer in the reactive composition with at least one silicon-oxygen bond, typically in the form of siloxy groups, siloxane groups, carbosiloxane groups, and mixtures thereof. Examples of silicone-containing components which are useful in this invention may be found in U.S. Pat. Nos. 3,808,178, 4,120,570, 4,136,250, 4,153,641, 4,740,533, 5,034,461, 5,070,215, 5,244,981, 5,314,960, 5,331,067, 5,371,147, 5,760,100, 5,849,811, 5,962,548, 5,965,631, 5,998,498, 6,367,929, 6,822,016, 6,943,203, 6,951,894, 7,052,131, 7,247,692, 7,396,890, 7,461,937, 7,468,398, 7,538,146, 7,553,880, 7,572,841, 7,666,921, 7,691,916, 7,786,185, 7,825,170, 7,915,323, 7,994,356, 8,022,158, 8,163,206, 8,273,802, 8,399,538, 8,415,404, 8,420,711, 8,450,387, 8,487,058, 8,568,626, 8,937,110, 8,937,111, 8,940,812, 8,980,972, 9,056,878, 9,125,808, 9,140,825, 9,156,934, 9,170,349, 9,217,813, 9,244,196, 9,244,197, 9,260,544, 9,297,928, 9,297,929, and European Patent No. 080539. These patents are hereby incorporated by reference in their entireties.

A “polymer” is a target macromolecule composed of the repeating units of the monomers and macromers used during polymerization.

A “homopolymer” is a polymer made from one monomer; a “copolymer” is a polymer made from two or more monomers; a “terpolymer” is a polymer made from three monomers. A “block copolymer” is composed of compositionally different blocks or segments. Diblock copolymers have two blocks. Triblock copolymers have three blocks. “Comb or graft copolymers” are made from at least one macromer.

A “repeating unit” is the smallest group of atoms in a polymer that corresponds to the polymerization of a specific monomer or macromer.

An “initiator” is a molecule that can decompose into free radical groups which can react with a monomer to initiate a free radical polymerization reaction. A thermal initiator decomposes at a certain rate depending on the temperature; typical examples are azo compounds such as 1,1′-azobisisobutyronitrile and 4,4′-aobis(4-cyanovaleric acid), peroxides such as benzoyl peroxide, tert-butyl peroxide, tert-butyl hydroperoxide, tert-butyl peroxybenzoate, dicumyl peroxide, and lauroyl peroxide, peracids such as peracetic acid and potassium persulfate as well as various redox systems. A photo-initiator decomposes by a photochemical process; typical examples are derivatives of benzil, benzoin, acetophenone, benzophenone, camphorquinone, and mixtures thereof as well as various monoacyl and bisacyl phosphine oxides and combinations thereof.

A “free radical group” is a molecule that has an unpaired valence electron which can react with a polymerizable group to initiate a free radical polymerization reaction.

A “cross-linking agent” or “crosslinker” is a di-functional or multi-functional monomer which can undergo free radical polymerization at two or more locations on the molecule, thereby creating branch points and a polymeric network. The two or more polymerizable functionalities on the crosslinker may be the same or different and may, for instance, be independently selected from vinyl groups (including allyl), (meth)acrylate groups, and (meth)acrylamide groups. Common examples are ethylene glycol dimethacrylate, tetraethylene glycol dimethacrylate, trimethylolpropane trimethacrylate, methylene bisacrylamide, triallyl cyanurate, and the like.

A “prepolymer” is a reaction product of monomers (or macromers) which contains remaining polymerizable groups capable of undergoing further reaction to form a polymer.

A “polymeric network” is a type of polymer that is in the form of a cross-linked macromolecule. Generally, a polymeric network may swell but cannot dissolve in solvents. For instance, the crosslinked substrate network of the invention is a material that is swellable, without dissolving.

“Hydrogels” are polymeric networks that swell in water or aqueous solutions, typically absorbing at least 10 weight percent water (at 25° C.). “Silicone hydrogels” are hydrogels that are made from at least one silicone-containing component with at least one hydrophilic component. Hydrophilic components may also include non-reactive polymers.

“Conventional hydrogels” refer to polymeric networks made from monomers without any siloxy, siloxane or carbosiloxane groups. Conventional hydrogels are prepared from reactive compositions predominantly containing hydrophilic monomers, such as 2-hydroxyethyl methacrylate (“HEMA”), N-vinyl pyrrolidone (“NVP”), N, N-dimethylacrylamide (“DMA”) or vinyl acetate.

As used herein, the term “reactive composition” refers to a composition containing one or more reactive components (and optionally non-reactive components) which are mixed (when more than one is present) together and, when subjected to polymerization conditions, form polymer compositions. If more than one component is present, the reactive composition may also be referred to herein as a “reactive mixture” or a “reactive monomer mixture” (or RMM). The reactive composition comprises reactive components such as the monomers, macromers, prepolymers, cross-linkers, and initiators, and optional additives such as wetting agents, release agents, dyes, light absorbing compounds such as UV-VIS absorbers, pigments, dyes and photochromic compounds, any of which may be reactive or non-reactive but are preferably capable of being retained within the resulting polymer composition, as well as pharmaceutical and nutraceutical compounds, and any diluents. It will be appreciated that a wide range of additives may be added based upon the final product which is made and its intended use. Concentrations of components of the reactive composition are expressed as weight percentages of all components in the reaction composition, excluding diluent. When diluents are used, their concentrations are expressed as weight percentages based upon the amount of all components in the reaction composition and the diluent.

“Reactive components” are the components in the reactive composition which become part of the chemical structure of the resulting material by covalent bonding, hydrogen bonding, electrostatic interactions, the formation of interpenetrating polymeric networks, or any other means. Examples include, but are not limited to silicone reactive components (e.g., the silicone-containing components described below) and hydrophilic reactive components (e.g., the hydrophilic monomers described below).

As used herein, the term “silicone hydrogel contact lens” refers to a contact lens comprising at least one silicone hydrogel. Silicone hydrogel contact lenses generally have increased oxygen permeability compared to conventional hydrogels. Silicone hydrogel contact lenses use both their water and polymer content to transmit oxygen to the eye.

The term “multi-functional” refers to a component having two or more polymerizable groups. The term “mono-functional” refers to a component having one polymerizable group.

The terms “halogen” or “halo” indicate fluorine, chlorine, bromine, and iodine.

As used herein, the term “alkyl” refers to an unsubstituted or substituted linear or branched alkyl group containing the indicated number of carbon atoms. If no number is indicated, then alkyl (optionally including any substituents on alkyl) may contain 1 to 16 carbon atoms. Preferably, the alkyl group contains 1 to 10 carbon atoms, alternatively 1 to 7 carbon atoms, or alternatively 1 to 4 carbon atoms. Examples of alkyl include methyl, ethyl, propyl, isopropyl, butyl, iso-, sec- and tert-butyl, pentyl, hexyl, heptyl, 3-ethylbutyl, and the like. Examples of substituents on alkyl include 1, 2, or 3 groups independently selected from hydroxy, amino, amido, oxa, carboxy, alkyl carboxy, carbonyl, alkoxy, amido, carbamate, carbonate, halogen, phenyl, benzyl, and combinations thereof “Alkylene” means a divalent alkyl group, such as —CH₂—, —CH₂CH₂—, —CH₂CH₂CH₂—, —CH₂CH(CH₃)CH₂—, and —CH₂CH₂CH₂CH₂—.

“Haloalkyl” refers to an alkyl group as defined above substituted with one or more halogen atoms, where each halogen is independently F, C₁, Br or I. A preferred halogen is F. Preferred haloalkyl groups contain 1-6 carbons, more preferably 1-4 carbons, and still more preferably 1-2 carbons. “Haloalkyl” includes perhaloalkyl groups, such as —CF₃— or —CF₂CF₃—. “Haloalkylene” means a divalent haloalkyl group, such as —CH₂CF₂—.

“Cycloalkyl” refers to an unsubstituted or substituted cyclic hydrocarbon containing the indicated number of ring carbon atoms. If no number is indicated, then cycloalkyl may contain 3 to 12 ring carbon atoms. Preferred are C₃-C₈ cycloalkyl groups, more preferably C₄-C₇ cycloalkyl, and still more preferably C₅-C₆ cycloalkyl. Examples of cycloalkyl include cyclopropyl, cyclobutyl, cyclopentyl, cyclohexyl, cycloheptyl and cyclooctyl. Examples of substituents on cycloalkyl include 1, 2, or 3 groups independently selected from alkyl, hydroxy, amino, amido, oxa, carbonyl, alkoxy, amido, carbamate, carbonate, halo, phenyl, benzyl, and combinations thereof. “Cycloalkylene” means a divalent cycloalkyl group, such as 1,2-cyclohexylene, 1,3-cyclohexylene, or 1,4-cyclohexylene.

“Heterocycloalkyl” refers to a cycloalkyl ring or ring system as defined above in which at least one ring carbon has been replaced with a heteroatom selected from nitrogen, oxygen, and sulfur. The heterocycloalkyl ring is optionally fused to or otherwise attached to other heterocycloalkyl rings and/or non-aromatic hydrocarbon rings and/or phenyl rings. Preferred heterocycloalkyl groups have from 5 to 7 members. More preferred heterocycloalkyl groups have 5 or 6 members. Heterocycloalkylene means a divalent heterocycloalkyl group.

“Aryl” refers to an unsubstituted or substituted aromatic hydrocarbon ring system containing at least one aromatic ring. The aryl group contains the indicated number of ring carbon atoms. If no number is indicated, then aryl may contain 6 to 14 ring carbon atoms. The aromatic ring may optionally be fused or otherwise attached to other aromatic hydrocarbon rings or non-aromatic hydrocarbon rings. Examples of aryl groups include phenyl, naphthyl, and biphenyl. Preferred examples of aryl groups include phenyl. Examples of substituents on aryl include 1, 2, or 3 groups independently selected from alkyl, hydroxy, amino, amido, oxa, carboxy, alkyl carboxy, carbonyl, alkoxy, amido, carbamate, carbonate, halo, phenyl, benzyl, and combinations thereof. “Arylene” means a divalent aryl group, for example 1,2-phenylene, 1,3-phenylene, or 1,4-phenylene.

“Heteroaryl” refers to an aryl ring or ring system, as defined above, in which at least one ring carbon atom has been replaced with a heteroatom selected from nitrogen, oxygen, and sulfur. The heteroaryl ring may be fused or otherwise attached to one or more heteroaryl rings, aromatic or nonaromatic hydrocarbon rings or heterocycloalkyl rings. Examples of heteroaryl groups include pyridyl, furyl, and thienyl. “Heteroarylene” means a divalent heteroaryl group.

“Alkoxy” refers to an alkyl group attached to the parent molecular moiety through an oxygen bridge. Examples of alkoxy groups include, for instance, methoxy, ethoxy, propoxy and isopropoxy. “Aryloxy” refers to an aryl group attached to a parent molecular moiety through an oxygen bridge. Examples include phenoxy. “Cyclic alkoxy” means a cycloalkyl group attached to the parent moiety through an oxygen bridge.

“Alkylamine” refers to an alkyl group attached to the parent molecular moiety through an —NH bridge. Alkyleneamine means a divalent alkylamine group, such as —CH₂CH₂NH—.

“Siloxanyl” refers to a structure having at least one Si—O—Si bond. Thus, for example, siloxanyl group means a group having at least one Si—O—Si group (i.e. a siloxane group), and siloxanyl compound means a compound having at least one Si—O—Si group. “Siloxanyl” encompasses monomeric (e.g., Si—O—Si) as well as oligomeric/polymeric structures (e.g., —[Si—O]ₙ—, where n is 2 or more). Each silicon atom in the siloxanyl group is substituted with independently selected R^{A} groups (where R^{A} is as defined in formula A options (b)-(i)) to complete their valence.

“Silyl” refers to a structure of formula R₃Si— and “siloxy” refers to a structure of formula R₃Si—O—, where each R in silyl or siloxy is independently selected from trimethylsiloxy, C₁-C₈ alkyl (preferably C₁-C₃ alkyl, more preferably ethyl or methyl), and C₃-C₈ cycloalkyl.

“Alkyleneoxy” refers to groups of the general formula -(alkylene-O)ₚ— or —(O-alkylene)ₚ-, wherein alkylene is as defined above, and p is from 1 to 200, or from 1 to 100, or from 1 to 50, or from 1 to 25, or from 1 to 20, or from 1 to 10, wherein each alkylene is independently optionally substituted with one or more groups independently selected from hydroxyl, halo (e.g., fluoro), amino, amido, ether, carbonyl, carboxyl, and combinations thereof. If p is greater than 1, then each alkylene may be the same or different and the alkyleneoxy may be in block or random configuration. When alkyleneoxy forms a terminal group in a molecule, the terminal end of the alkyleneoxy may, for instance, be a hydroxy or alkoxy (e.g., HO—[CH₂CH₂O]ₚ— or CH₃O—[CH₂CH₂O]ₚ—). Examples of alkyleneoxy include polymethyleneoxy, polyethyleneoxy, polypropyleneoxy, polybutyleneoxy, and poly(ethyleneoxy-co-propyleneoxy).

“Oxaalkylene” refers to an alkylene group as defined above where one or more non-adjacent CH₂ groups have been substituted with an oxygen atom, such as —CH₂CH₂OCH(CH₃)CH₂—. “Thiaalkylene” refers to an alkylene group as defined above where one or more non-adjacent CH₂ groups have been substituted with a sulfur atom, such as —CH₂CH₂SCH(CH₃)CH₂—.

The term “linking group” refers to a moiety that links the polymerizable group to the parent molecule. The linking group may be any moiety that does not undesirably interfere with the polymerization of the compound of which it is a part. For instance, the linking group may be a bond, or it may comprise one or more alkylene, haloalkylene, amide, amine, alkyleneamine, carbamate, carboxylate (—CO₂—), arylene, heteroarylene, cycloalkylene, heterocycloalkylene, alkyleneoxy, oxaalkylene, thiaalkylene, haloalkyleneoxy (alkyleneoxy substituted with one or more halo groups, e.g., —OCF₂—, —OCF₂CF₂—, —OCF₂CH₂—), siloxanyl, alkylenesiloxanyl, or combinations thereof. The linking group may optionally be substituted with 1 or more substituent groups. Suitable substituent groups may include those independently selected from alkyl, halo (e.g., fluoro), hydroxyl, HO-alkyleneoxy, MeO-alkyleneoxy, siloxanyl, siloxy, siloxy-alkyleneoxy-, siloxy-alkylene-alkyleneoxy- (where more than one alkyleneoxy groups may be present and wherein each methylene in alkylene and alkyleneoxy is independently optionally substituted with hydroxyl), ether, amine, carbonyl, carbamate, and combinations thereof. The linking group may also be substituted with a polymerizable group, such as (meth)acrylate.

Preferred linking groups include C₁-C₈ alkylene (preferably C₂-C₆ alkylene) and C₁-C₈ oxaalkylene (preferably C₂-C₆ oxaalkylene), each of which is optionally substituted with 1 or 2 groups independently selected from hydroxyl and siloxy. Preferred linking groups also include carboxylate, amide, C₁-C₈ alkylene-carboxylate-C₁-C₈ alkylene, or C₁-C₈ alkylene-amide-C₁-C₈ alkylene.

When the linking group is comprised of combinations of moieties as described above (e.g., alkylene and cycloalkylene), the moieties may be present in any order. For instance, if in Formula E below, L is indicated as being -alkylene-cycloalkylene-, then Rg-L may be either Rg-alkylene-cycloalkylene-, or Rg-cycloalkylene-alkylene-. Notwithstanding this, the listing order represents the preferred order in which the moieties appear in the compound starting from the terminal polymerizable group (Rg) to which the linking group is attached. For example, if in Formula E, L and L² are indicated as both being alkylene-cycloalkylene, then Rg-L is preferably Rg-alkylene-cycloalkylene- and -L²-Rg is preferably -cycloalkylene-alkylene-Rg.

As noted above, the invention provides a process for making an ophthalmic device. The process comprises: (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker; (b) subjecting the first reactive composition to a first activation step such that the first reactive composition polymerizes therein to form a crosslinked substrate network containing a covalently bound activatable free radical initiator; (c) contacting the crosslinked substrate network with a grafting composition containing a shrinking agent and one or more ethylenically unsaturated compounds; and (d) activating the covalently bound activatable free radical initiator of the crosslinked substrate network such that the grafting composition polymerizes therein with the crosslinked substrate network.

The polymerization initiator may be any composition with the ability to generate free radical groups in two or more separate activation steps. There is no particular requirement in the invention with respect to what type of polymerization initiator is used or the mechanism of activation, as long as the first activation and the second activation can be conducted sequentially. Thus, suitable polymerization initiators may, for example, be activated thermally, by visible light, by ultraviolet light, via electron beam irradiation, by gamma ray irradiation, or combinations thereof. Examples of polymerization initiators that may be used in the invention include, without limitation, bisacylphosphine oxides (“BAPO”), bis(acyl)phosphane oxides (e.g., bis(mesitoyl)phosphinic acid), azo compounds, peroxides, alpha-hydroxy ketones, alpha-alkoxy ketones, 1, 2-diketones, germanium based compounds (such as bis(4-methoxybenzoyl)diethylgermanium), or combinations thereof.

BAPO initiators are preferred. Examples of suitable BAPO initiators include, without limitation, compounds having the chemical structure of formula I:

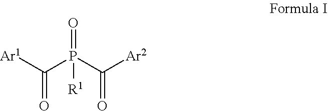

wherein Ar¹ and Ar² are independently substituted or unsubstituted aryl groups, typically substituted phenyl groups, wherein the substituents are linear, branched, or cyclic alkyl groups, such as methyl groups, linear, branched, or cyclic alkoxy groups, such as methoxy groups, and halogen atoms; preferably Ar¹ and Ar² have identical chemical structures; and wherein R¹ is a linear, branched, or cyclic alky group having from 1 to 10 carbon atoms, or R¹ is a phenyl group, a hydroxyl group, or an alkoxy group having from 1 to 10 carbon atoms.

Polymerization initiators that are activatable by different types of energy for the initial and subsequent activations may also be used. For instance, materials that undergo a first thermal activation and a second activation via irradiation are within the scope of the invention. Examples of such mixed activation materials include compounds of formulae II, III, IV, and V:

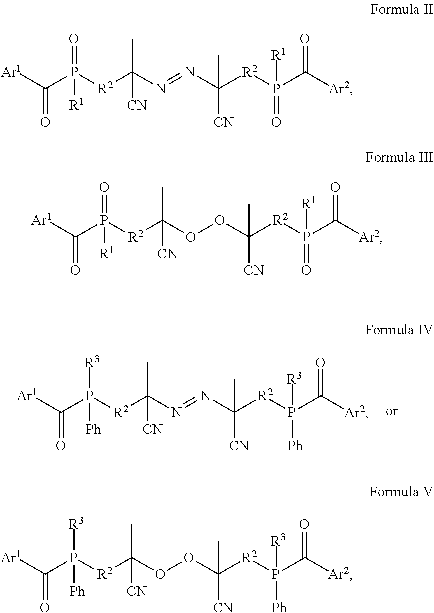

wherein Ar¹ and Ar² are independently substituted or unsubstituted aryl groups, typically substituted phenyl groups, wherein the substituents are linear, branched, or cyclic alkyl groups, such as methyl groups, linear, branched, or cyclic alkoxy groups, such as methoxy groups, and halogen atoms; preferably Ar¹ and Ar² have identical chemical structures; and wherein R¹ is a linear, branched, or cyclic alkyl group having from 1 to 10 carbon atoms; wherein R² is difunctional methylene linking group that may further comprise ether, ketone, or ester groups along the methylene chain having from 1 to 10 carbon atoms; and R³ is a hydrogen atom, a hydroxyl group, or a linear, branched, or cyclic alkoxy group having from 1 to 10 carbon atoms. A further example is tert-butyl 7-methyl-7-(tert-butylazo)peroxyoctanoate.

Furthermore, diazo compounds, diperoxy compounds, or azo-peroxy compounds that exhibit two distinct decomposition temperatures may be used in the prevent invention.

Preferably, the polymerization initiator is a photopolymerization initiator, preferably a bisacylphosphine oxide. Bisacylphosphine oxides are desirable because they can undergo sequential activations steps at different wavelengths and are therefore simple to use. At the longer wavelength, bisacylphosphine oxides can form two free radical groups, one of which is a monoacylphosphine oxide. The monacylphosphine oxide (MAPO) can then undergo a second activation, typically at a shorter wavelength. A particularly preferred bisacylphosphine oxide is bis(2,4,6-trimethylbenzoyl) phenylphosphine oxide, for which the longer wavelength is typically above 420 nm (e.g., 435 nm and above) and the shorter wavelength is typically 420 nm and below. It may be preferable to use an LED or equivalent light in which the bandwidths are relatively narrow as the radiation source, thereby allowing initial irradiation while preserving some or most of the MAPO groups in the crosslinked substrate network.

Other exemplary bisacylphosphine oxide compounds that may be used include bis-(2,6-dimethoxybenzoyl)-2,4,4-trimethylpenthylphosphine oxide, bis(2,4,6-trimethylbenzoyl)-2,4,4-trimethylpenthylphosphine oxide, or bis(2,4,6-trimethylbenzoyl)phosphinic acid or salt thereof.

In the invention, the first reactive composition, which contains the polymerization initiator, one or more ethylenically unsaturated compounds, and a crosslinker, is subjected to a first activation step under conditions that cause the polymerization initiator to undergo its initial activation. For example, if the polymerization initiator is a BAPO, the first reactive composition may be irradiated at 435 nm or above using an appropriate light source. The first reactive composition consequently polymerizes to form a crosslinked substrate network. The crosslinked substrate network contains the residue of the polymerization initiator as a covalently bound activatable free radical initiator.

The activation and polymerization of the first reactive composition may be carried out using techniques known to those skilled in the art. For example, the reactive components of the first reactive composition may be mixed in a vessel. A diluent may optionally be used to facilitate the mixing. The mixture may be filtered, degassed, and heated to a desired temperature and then irradiated under conditions to cause a first activation of the polymerization initiator and consequent formation of the crosslinked substrate network. The vessel for the polymerization may be a mold, for instance where it is desired for the product to have a specific shape. For example, the first reactive composition may be dosed and polymerized within the cavity of a mold pair (e.g., front and back molds). Preferably, the first crosslinked substrate network for use in ophthalmic devices of invention is a conventional or a silicone hydrogel. More preferably, it is a silicone hydrogel.

According to the invention, the crosslinked substrate network formed as described above is contacted with a grafting composition. The grafting composition contains one or more ethylenically unsaturated compounds. In addition, the grafting composition contains a shrinking agent. As discussed above, the shrinking agent advantageously causes the crosslinked substrate network to shrink, thereby off-setting some of the swelling of the crosslinked substrate network that would otherwise occur if the shrinking agent wasn't present. This shrinking limits diffusion of ethylenically unsaturated compound into the bulk of the crosslinked substrate network thereby resulting in preferentially surface functionalization during polymerization of step (d) of the process. Furthermore, the shrinking agent aids in facilitating the grafting process.

Shrinking agents for use in the invention may include, for example, ammonium salts or metal salts, such as alkali metal salts or alkali earth metal salts. The term “alkali metal” refers to an element from Group 1 of the periodic table and the term “alkaline earth metal” refers to an element from Group 2 of the periodic. Alkali metal and alkali earth metal salts may be of the of formula MA, where M is one or more ammonium, alkali metal, or alkali earth metal cation and A is one or more counterions (which may be a group of atoms). Examples of M include lithium, sodium, potassium, rubidium, cesium, beryllium, magnesium, calcium, strontium, and barium. Example of A include halides, phosphates, carbonates, bicarbonates, carboxylates, alkoxides, nitrates, chlorates, perchlorates, borates, thiocyanates, and the like. Further examples of A include chloride, carbonate, and sulfate. Preferably, M is an alkali metal cation, preferably sodium or potassium, more preferably sodium. Preferably, A is a halide such as chloride, or is carbonate. Exemplary salts for use as shrinking agents in the invention include sodium chloride, sodium carbonate, and potassium chloride. A preferred shrinking agent is sodium chloride.

To facilitate migration into the crosslinked substrate network, it is preferable that the shrinking agent be soluble in the grafting composition. Solubility may be provided, for instance, through use of an appropriate solvent. For instance, if the shrinking agent is an alkali metal salt such as sodium chloride, the grafting composition may be dispersed or dissolved in solvent containing a sufficient amount of water to dissolve the shrinking agent. Preferably, the grafting composition is in the form of an aqueous composition.

The contacting of the crosslinked substrate network with the grafting composition is preferably conducted by immersing the crosslinked substrate network in a liquid or solution containing the grafting composition (including the shrinking agent) for sufficient time to permit maximum size reduction of the crosslinked substrate network as well as allowing for the grafting composition to partially penetrate into the substrate. By way of example, such contacting may occur for 1 minute or longer, or 5 minutes longer. By way of further example, such contacting may occur for up to 250 minutes, or up to 120 minutes, or up to 60 minutes, or up to 30 minutes, or up to 15 minutes. Typical contacting times may include, for instance, from 1 minute to 30 minutes, of from 5 minutes to 15 minutes.

Following the contacting of the crosslinked substrate network with the grafting composition, at least some of the activatable free radical initiator of the crosslinked substrate network is activated. For example, if the polymerization initiator used in step (a) of the process is a BAPO, then at least some of the free radical initiator covalently bound to the crosslinked substrate network (in this example, a monoacylphosphine oxide) may be activated by irradiation at 420 nm or below using an appropriate light source. The ethylenically unsaturated compounds in the grafting composition then undergo polymerization, and covalently graft with the crosslinked substrate network via the free radical initiator in the substrate. The product is thus an ophthalmic device that is comprised of a grafted polymeric network. Preferably, where the ophthalmic device is a soft hydrogel contact lens having, for instance, a center thickness of 30 to 300 microns, the grafting composition (after the curing) has penetrated to a maximum depth of up to 30% of the center thickness, preferably up to 20% of the center thickness, more preferably up to 10% of center thickness, most preferably up to 5% of the center thickness, or alternatively, the cured grafted composition layer may have a thickness at the center of the lens of up to 90 microns, preferably between 9 and 90 microns, more preferably between 6 and 60 microns, and most preferably between 3 and 30 microns. Methods for determining the extent of penetration are known and include, for instance, confocal microscopy as described in U.S. Ser. No. 10/961,341. Additional optional grafting steps may be added. For instance, following the above-described grafting, the grafted crosslinked substrate network may be contacted with a second grafting composition containing one or more ethylenically unsaturated compounds. Such second composition may be grafted onto the substrate if the substrate contains residual covalently bound activatable free radical initiators.

It should be noted that the free radical initiator covalently bound to the crosslinked substrate network forms two free radical groups when activated, one of which may not be covalently bound to the substrate. Consequently, some of the reactive components in the grafting composition may polymerize via the unbound free radical group to form a polymer that is not covalently bound with the network. Such polymer is referred to herein as a “byproduct polymer.” This byproduct polymer may be induced to covalently bind with the grafted polymeric network by inclusion of a crosslinking agent in the grafting composition. The composition may contain at least a portion of the byproduct polymer that is not covalently bound to the grafted polymeric network. To achieve this, the polymerization of the grafting composition is conducted in the substantial absence of a crosslinker. By “substantial absence of a crosslinker” is meant that any crosslinker used in the grafting composition is present in less than a stoichiometric amount (i.e., less than the amount necessary for complete crosslinking of the byproduct polymer into the network). In some embodiments, no crosslinker is present in the grafting composition.

The activation and polymerization of the grafting composition and the crosslinked substrate network may, for example, be carried out by mixing the reactive components and the substrate in a vessel. A diluent may optionally be used to facilitate the mixing and to help swell the substrate (e.g., if it is not already swollen or hydrated). The mixture may be degassed, heated, equilibrated, and irradiated under conditions to cause activation of the covalently bound activatable free radical initiator.

The first reactive composition and the grafting composition(s) of the invention contain ethylenically unsaturated compounds as reactive components. The ethylenically unsaturated compounds undergo polymerization to form the polymer compositions described herein. As will be appreciated, a wide variety of ethylenically unsaturated compounds may be used in the invention.

The ethylenically unsaturated compounds may be the same or different between the first reactive composition and the grafting composition, although in some embodiments, it is preferable that at least some of the ethylenically unsaturated compounds in each composition are different. By using materials for the first reactive composition that are different from the grafting composition, it becomes possible to design ophthalmic devices that combine desirable properties from materials that may otherwise not be readily compatible. This is one of the advantages of the invention.

The ethylenically unsaturated compound for inclusion in the first reactive composition and/or the grafting composition may comprise an independently selected silicone-containing component.

The silicone-containing component may comprise one or more compounds selected from monomers or macromer, where each compound may independently comprise at least one polymerizable group, at least one siloxane group, and one or more linking groups connecting the polymerizable group(s) to the siloxane group(s). The silicone-containing components may, for instance, contain from 1 to 220 siloxane repeat units, such as the groups defined below. The silicone-containing component may also contain at least one fluorine atom.

The silicone-containing component may comprise: one or more polymerizable groups as defined above; one or more optionally repeating siloxane units; and one or more linking groups connecting the polymerizable groups to the siloxane units. The silicone-containing component may comprise: one or more polymerizable groups that are independently a (meth)acrylate, a styryl, a vinyl ether, a (meth)acrylamide, an N-vinyllactam, an N-vinylamide, an O-vinylcarbamate, an O-vinylcarbonate, a vinyl group, or mixtures of the foregoing; one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, an N-vinyl lactam, an N-vinylamide, a styryl, or mixtures of the foregoing; one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, or mixtures of the foregoing; one or more optionally repeating siloxane units; and one or more linking groups connecting the polymerizable groups to the siloxane units.

Formula A. The silicone-containing component may comprise one or more siloxane monomers or macromers of Formula A:

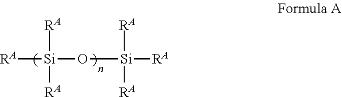

wherein:
at least one R^{A} is a group of formula R_{g}-L- wherein R_{g} is a polymerizable group and L is a linking group, and the remaining R^{A} are each independently:
   (a) R_{g}-L-,
   (b) C₁-C₁₆ alkyl optionally substituted with one or more hydroxy, amino, amido, oxa, carboxy, alkyl carboxy, carbonyl, alkoxy, amido, carbamate, carbonate, halo, phenyl, benzyl, or combinations thereof,
   (c) C₃-C₁₂ cycloalkyl optionally substituted with one or more alkyl, hydroxy, amino, amido, oxa, carbonyl, alkoxy, amido, carbamate, carbonate, halo, phenyl, benzyl, or combinations thereof,
   (d) a C₆-C₁₄ aryl group optionally substituted with one or more alkyl, hydroxy, amino, amido, oxa, carboxy, alkyl carboxy, carbonyl, alkoxy, amido, carbamate, carbonate, halo, phenyl, benzyl, or combinations thereof,
   (e) halo,
   (f) alkoxy, cyclic alkoxy, or aryloxy,
   (g) siloxy,
   (h) alkyleneoxy-alkyl or alkoxy-alkyleneoxy-alkyl, such as polyethyleneoxyalkyl, polypropyleneoxyalkyl, or poly(ethyleneoxy-co-propyleneoxyalkyl), or
   (i) a monovalent siloxane chain comprising from 1 to 100 siloxane repeat units optionally substituted with alkyl, alkoxy, hydroxy, amino, oxa, carboxy, alkyl carboxy, alkoxy, amido, carbamate, halo or combinations thereof; and
n is from 0 to 500 or from 0 to 200, or from 0 to 100, or from 0 to 20, where it is understood that when n is other than 0, n is a distribution having a mode equal to a stated value. When n is 2 or more, the SiO units may carry the same or different R^{A} substituents and if different R^{A} substituents are present, the n groups may be in random or block configuration.

In Formula A, three R^{A} may each comprise a polymerizable group, alternatively two R^{A} may each comprise a polymerizable group, or alternatively one R^{A} may comprise a polymerizable group.

Formula B. The silicone-containing component of formula A may be a mono-functional compound of formula B:

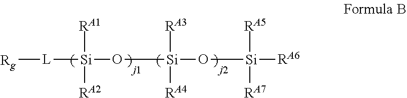

wherein:

Rg is a polymerizable group;

L is a linking group;

j1 and j2 are each independently whole numbers from 0 to 220, provided that the sum of j1 and j2 is from 1 to 220;

R^{A1}, R^{A2}, R^{A3}, R^{A4}, R^{A5}, and R^{A7} are independently at each occurrence C₁-C₆ alkyl, C₃-C₁₂ cycloalkyl, C₁-C₆ alkoxy, C₄-C₁₂ cyclic alkoxy, alkoxy-alkyleneoxy-alkyl, aryl (e.g., phenyl), aryl-alkyl (e.g., benzyl), haloalkyl (e.g., partially or fully fluorinated alkyl), siloxy, fluoro, or combinations thereof, wherein each alkyl in the foregoing groups is optionally substituted with one or more hydroxy, amino, amido, oxa, carboxy, alkyl carboxy, carbonyl, alkoxy, carbamate, carbonate, halo, phenyl, or benzyl, each cycloalkyl is optionally substituted with one or more alkyl, hydroxy, amino, amido, oxa, carbonyl, alkoxy, carbamate, carbonate, halo, phenyl, or benzyl and each aryl is optionally substituted with one or more alkyl, hydroxy, amino, amido, oxa, carboxy, alkyl carboxy, carbonyl, alkoxy, carbamate, carbonate, halo, phenyl, or benzyl; and

R^{A6} is siloxy, C₁-C₈ alkyl (e.g., C₁-C₄ alkyl, or butyl, or methyl), or aryl (e.g., phenyl), wherein alkyl and aryl may optionally be substituted with one or more fluorine atoms.

Formula B-1. Compounds of formula B may include compounds of formula B-1, which are compounds of formula B wherein j1 is zero and j2 is from 1 to 220, or j2 is from 1 to 100, or j2 is from 1 to 50, or j2 is from 1 to 20, or j2 is from 1 to 5, or j2 is 1.

B-2. Compounds of formula B may include compounds of formula B-2, which are compounds of formula B wherein j1 and j2 are independently from 4 to 100, or from 4 to 20, or from 4 to 10, or from 24 to 100, or from 10 to 100.

B-3. Compounds of formulae B, B-1, and B-2 may include compounds of formula B-3, which are compounds of formula B, B-1, or B-2 wherein R^{A1}, R^{A2}, R^{A3}, and R^{A4} are independently at each occurrence C₁-C₆ alkyl or siloxy. Preferred alkyl are C₁-C₃ alkyl, or more preferably, methyl. Preferred siloxy is trimethylsiloxy.

B-4. Compounds of formulae B, B-1, B-2, and B-3 may include compounds of formula B-4, which are compounds of formula B, B-1, B-2, or B-3 wherein R^{A5} and R^{A7} are independently alkoxy-alkyleneoxy-alkyl, preferably they are independently a methoxy capped polyethyleneoxyalkyl of formula CH₃O—[CH₂CH₂O]ₚ—CH₂CH₂CH₂, wherein p is a whole number from 1 to 50.

B-5. Compounds of formulae B, B-1, B-2, and B-3 may include compounds of formula B-5, which are compounds of formula B, B-1, B-2, or B-3 wherein R^{A5} and R^{A7} are independently siloxy, such as trimethylsiloxy.

B-6. Compounds of formulae B, B-1, B-2, and B-3 may include compounds of formula B-6, which are compounds of formula B, B-1, B-2, or B-3 wherein R^{A5} and R^{A7} are independently C₁-C₆ alkyl, alternatively C₁-C₄ alkyl, or alternatively, butyl or methyl.

B-7. Compounds of formulae B, B-1, B-2, B-3, B-4, B-5, and B-6 may include compounds of formula B-7, which are compounds of formula B, B-1, B-2, B-3, B-4, B-5, or B-6 wherein R^{A6} is C₁-C₈ alkyl, preferably C₁-C₆ alkyl, more preferably C₁-C₄ alkyl (for example methyl, ethyl, n-propyl, or n-butyl). More preferably R^{A6} is n-butyl.

B-8. Compounds of formulae B, B-1, B-2, B-3, B-4, B-5, B-6, and B-7, may include compounds of formula B-8, which are compounds of formula B, B-1, B-2, B-3, B-4, B-5, B-6, or B-7 wherein Rg comprises styryl, vinyl carbonate, vinyl ether, vinyl carbamate, N-vinyl lactam, N-vinylamide, (meth)acrylate, or (meth)acrylamide. Preferably, Rg comprises (meth)acrylate, (meth)acrylamide, or styryl. More preferably, Rg comprises (meth)acrylate or (meth)acrylamide. When Rg is (meth)acrylamide, the nitrogen group may be substituted with R^{A9}, wherein R^{A9} is H, C₁-C₈ alkyl (preferably C₁-C₄ alkyl, such as n-butyl, n-propyl, methyl or ethyl), or C₃-C₈ cycloalkyl (preferably C₅-C₆ cycloalkyl), wherein alkyl and cycloalkyl are optionally substituted with one or more groups independently selected from hydroxyl, amide, ether, silyl (e.g., trimethylsilyl), siloxy (e.g., trimethylsiloxy), alkyl-siloxanyl (where alkyl is itself optionally substituted with fluoro), aryl-siloxanyl (where aryl is itself optionally substituted with fluoro), and silyl-oxaalkylene- (where the oxaalkylene is itself optionally substituted with hydroxyl).

B-9. Compounds of formulae B, B-1, B-2, B-3, B-4, B-5, B-6, B-7, and B-8 may include compounds of formula B-9, which are compounds of formula B, B-1, B-2, B-3, B-4, B-5, B-6, B-7, or B-8 wherein the linking group comprises alkylene (preferably C₁-C₄ alkylene), cycloalkylene (preferably C₅-C₆ cycloalkylene), alkyleneoxy (preferably ethyleneoxy), haloalkyleneoxy (preferably haloethyleneoxy), amide, oxaalkylene (preferably containing 3 to 6 carbon atoms), siloxanyl, alkylenesiloxanyl, carbamate, alkyleneamine (preferably C₁-C₆ alkyleneamine), or combinations of two or more thereof, wherein the linking group is optionally substituted with one or more substituents independently selected from alkyl, hydroxyl, ether, amine, carbonyl, siloxy, and carbamate.

B-10. Compounds of formulae B, B-1, B-2, B-3, B-4, B-5, B-6, B-7, B-8, and B-9 may include compounds of formula B-10, which are compounds of formula B, B-1, B-2, B-3, B-4, B-5, B-6, B-7, B-8, or B-9 wherein the linking group is alkylene-siloxanyl-alkylene-alkyleneoxy-, or alkylene-siloxanyl-alkylene-[alkyleneoxy-alkylene-siloxanyl]_{q}-alkyleneoxy-, where q is from 1 to 50.

B-11. Compounds of formulae B, B-1, B-2, B-3, B-4, B-5, B-6, B-7, B-8, and B-9 may include compounds of formula B-11, which are compounds of formula B, B-1, B-2, B-3, B-4, B-5, B-6, B-7, B-8, or B-9 wherein the linking group is C₁-C₆ alkylene, preferably C₁-C₃ alkylene, more preferably n-propylene.

B-12. Compounds of formulae B, B-1, B-2, B-3, B-4, B-5, B-6, B-7, B-8, and B-9 may include compounds of formula B-12, which are compounds of formula B, B-1, B-2, B-3, B-4, B-5, B-6, B-7, B-8, or B-9 wherein the linking group is alkylene-carbamate-oxaalkylene. Preferably, the linking group is CH₂CH₂N(H)—C(═O)—O—CH₂CH₂—O—CH₂CH₂CH₂.

B-13. Compounds of formulae B, B-1, B-2, B-3, B-4, B-5, B-6, B-7, B-8, and B-9 may include compounds of formula B-13, which are compounds of formula B, B-1, B-2, B-3, B-4, B-5, B-6, B-7, B-8, or B-9 wherein the linking group is oxaalkylene. Preferably, the linking group is CH₂CH₂—O—CH₂CH₂CH₂.

B-14. Compounds of formulae B, B-1, B-2, B-3, B-4, B-5, B-6, B-7, B-8, and B-9 may include compounds of formula B-14, which are compounds of formula B, B-1, B-2, B-3, B-4, B-5, B-6, B-7, B-8, or B-9 wherein the linking group is alkylene-[siloxanyl-alkylene]_{q}-, where q is from 1 to 50. An example of such a linking group is: —(CH₂)₃—[Si(CH₃)₂—O—Si(CH₃)₂—(CH₂)₂]_{q}—.

B-15. Compounds of formulae B, B-1, B-2, B-3, B-4, B-5, B-6, B-7, B-8, and B-9 may include compounds of formula B-15, which are compounds of formula B, B-1, B-2, B-3, B-4, B-5, B-6, B-7, B-8, or B-9 wherein the linking group is alkyleneoxy-carbamate-alkylene-cycloalkylene-carbamate-oxaalkylene, wherein cycloalkylene is optionally substituted with or 1, 2, or 3 independently selected alkyl groups (preferably C₁-C₃ alkyl, more preferably methyl). An example of such a linking group is —[OCH₂CH₂]_{q}—OC(═O)—NH—CH₂-[1,3-cyclohexylene]-NHC(═O)O—CH₂CH₂—O—CH₂CH₂—, wherein the cyclohexylene is substituted at the 1 and 5 positions with 3 methyl groups.

B-16. Compounds of formulae B, B-1, B-2, B-3, B-4, B-5, B-6, B-7, B-8, and B-9 may include compounds of formula B-16, which are compounds of formula B, B-1, B-2, B-3, B-4, B-5, B-6, B-7, B-8, or B-9 wherein Rg comprises styryl and the linking group is alkyleneoxy wherein each alkylene in alkyleneoxy is independently optionally substituted with hydroxyl. An example of such a linking group is —O—(CH₂)₃—. Another example of such a linking group is —O—CH₂CH(OH)CH₂—O—(CH₂)₃—.

B-17. Compounds of formulae B, B-1, B-2, B-3, B-4, B-5, B-6, B-7, B-8, and B-9 may include compounds of formula B-17, which are compounds of formula B, B-1, B-2, B-3, B-4, B-5, B-6, B-7, B-8, or B-9 wherein Rg comprises styryl and the linking group is alkyleneamine. An example of such a linking group is —NH—(CH₂)₃—.

B-18. Compounds of formulae B, B-1, B-2, B-3, B-4, B-5, B-6, B-7, B-8, and B-9 may include compounds of formula B-18, which are compounds of formula B, B-1, B-2, B-3, B-4, B-5, B-6, B-7, B-8, or B-9 wherein the linking group is oxaalkylene optionally substituted with hydroxyl, siloxy, or silyl-alkyleneoxy (where the alkyleneoxy is itself optionally substituted with hydroxyl). An example of such a linking group is —CH₂CH(G)CH₂—O—(CH₂)₃—, wherein G is hydroxyl. In another example, G is R₃SiO— wherein two R groups are trimethylsiloxy and the third is C₁-C₈ alkyl (preferably C₁-C₃ alkyl, more preferably methyl) or the third is C₃-C₈ cycloalkyl. In a further example, G is R₃Si—(CH₂)₃—O—CH₂CH(OH)CH₂—O—, wherein two R groups are trimethylsiloxy and the third is C₁-C₈ alkyl (preferably C₁-C₃ alkyl, more preferably methyl) or C₃-C₈ cycloalkyl. In a still further example, G is a polymerizable group, such as (meth)acrylate. Such compounds may function as crosslinkers.

B-19. Compounds of formulae B, B-1, B-2, B-3, B-4, B-5, B-6, B-7, B-8, and B-9 may include compounds of formula B-19, which are compounds of formula B, B-1, B-2, B-3, B-4, B-5, B-6, B-7, B-8, or B-9 wherein Rg comprises styryl and the linking group is amine-oxaalkylene optionally substituted with hydroxyl. An example of such a linking group is —NH—CH₂CH(OH)CH₂—O—(CH₂)₃—.

B-20. Compounds of formulae B, B-1, B-2, B-3, B-4, B-5, B-6, B-7, B-8, and B-9 may include compounds of formula B-20, which are compounds of formula B, B-1, B-2, B-3, B-4, B-5, B-6, B-7, B-8, or B-9 wherein Rg comprises styryl and the linking group is alkyleneoxy-carbamate-oxaalkylene. An example of such a linking group is —O—(CH₂)₂—N(H)C(═O)O—(CH₂)₂—O—(CH₂)₃—.

B-21. Compounds of formulae B, B-1, B-2, B-3, B-4, B-5, B-6, B-7, B-8, and B-9 may include compounds of formula B-21, which are compounds of formula B, B-1, B-2, B-3, B-4, B-5, B-6, B-7, B-8, or B-9 wherein the linking group is alkylene-carbamate-oxaalkylene. An example of such a linking group is —(CH₂)₂—N(H)C(═O)O—(CH₂)₂—O—(CH₂)₃—.

Formula C. Silicone-containing components of formulae A, B, B-1, B-2, B-3, B-4, B-5, B-6, B-7, B-8, B-9, B-10, B-11, B-12, B-13, B-14, B-15, B-18, and B-21 may include compounds of formula C, which are compounds of formula A, B, B-1, B-2, B-3, B-4, B-5, B-6, B-7, B-8, B-9, B-10, B-11, B-12, B-13, B-14, B-15, B-18, or B-21 having the structure:

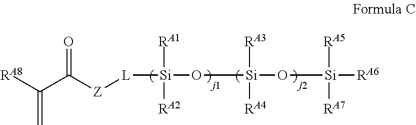

wherein

R^{A8} is hydrogen or methyl;

Z is O, S, or N(R^{A9}); and

L, j1, j2, R^{A1}, R^{A2}, R^{A3}, R^{A4}, R^{A5}, R^{A6}, R^{A7}, and R^{A9} are as defined in formula B or its various sub-formulae (e.g., B-1, B-2, etc.).

C-1. Compounds of formula C may include (meth)acrylates of formula C-1, which are compounds of formula C wherein Z is O.

C-2. Compounds of formula C may include (meth)acrylamides of formula C-2, which are compounds of formula C wherein Z is N(R^{A9}), and R^{A9} is H.

C-3. Compounds of formulae C may include (meth)acrylamides of formula C-3, which are compounds of formula C wherein Z is N(R^{A9}), and R^{A9} is C₁-C₈ alkyl that is unsubstituted or is optionally substituted as indicated above. Examples of R^{A9} include

CH₃, —CH₂CH(OH)CH₂(OH), —(CH₂)₃-siloxanyl, —(CH₂)₃—SiR₃, and —CH₂CH(OH)CH₂—O—(CH₂)₃—SiR₃ where each R in the foregoing groups is independently selected from trimethylsiloxy, C₁-C₈ alkyl (preferably C₁-C₃ alkyl, more preferably methyl), and C₃-C₈ cycloalkyl. Further examples of R^{A9} include: —(CH₂)₃— Si(Me)(SiMe₃)₂, and —(CH₂)₃— Si(Me₂)-[O-SiMed₂]₁₋₁₀—CH₃.

Formula D. Compounds of formula C may include compounds of formula D:

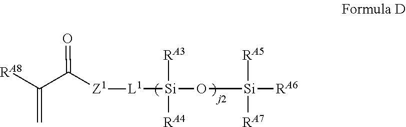

wherein

R^{A8} is hydrogen or methyl;

Z¹ is O or N(R^{A9});

L¹ is alkylene containing 1 to 8 carbon atoms, or oxaalkylene containing 3 to 10 carbon atoms, wherein L¹ is optionally substituted with hydroxyl; and

j2, R^{A3}, R^{A4}, R^{A5}, R^{A6}, R^{A7}, and R^{A9} are as defined above in formula B or its various sub-formulae (e.g., B-1, B-2, etc.).

D-1. Compounds of formula D may include compounds of formula D-1, which are compounds of formula D wherein L¹ is C₂-C₅ alkylene optionally substituted with hydroxyl. Preferably L¹ is n-propylene optionally substituted with hydroxyl.

D-2. Compounds of formula D may include compounds of formula D-2, which are compounds of formula D wherein L¹ is oxaalkylene containing 4 to 8 carbon atoms optionally substituted with hydroxyl. Preferably L¹ is oxaalkylene containing five or six carbon atoms optionally substituted with hydroxyl. Examples include —(CH₂)₂—O—(CH₂)₃—, and —CH₂CH(OH)CH₂—O—(CH₂)₃—.

D-3. Compounds of formulae D, D-1, and D-2 may include compounds of formula D-3, which are compounds of formula D, D-1, or D-2 wherein Z¹ is O.

D-4. Compounds of formulae D, D-1, and D-2 may include compounds of formula D-4, which are compounds of formula D, D-1, or D-2 wherein Z¹ is N(R^{A9}), and R^{A9} is H.

D-5. Compounds of formulae D, D-1, and D-2 may include compounds of formula D-5, which are compounds of formula D, D-1, or D-2 wherein Z¹ is N(R^{A9}), and R^{A9} is C₁-C₄ alkyl optionally substituted with 1 or 2 substituents selected from hydroxyl, siloxy, and C₁-C₆ alkyl-siloxanyl-.

D-6. Compounds of formulae D, D-1, D-2, D-3, D-4, and D-5 may include compounds of formula D-6, which are compounds of formula D, D-1, D-2, D-3, D-4, or D-5 wherein j2 is 1.

D-7. Compounds of formulae D, D-1, D-2, D-3, D-4, and D-5 may include compounds of formula D-7, which are compounds of formula D, D-1, D-2, D-3, D-4, or D-5 wherein j2 is from 2 to 220, or from 2 to 100, or from 10 to 100, or from 24 to 100, or from 4 to 20, or from 4 to 10.

D-8. Compounds of formulae D, D-1, D-2, D-3, D-4, D-5, D-6, and D-7 may include compounds of formula D-8, which are compounds of formula D, D-1, D-2, D-3, D-4, D-5, D-6, or D-7 wherein R^{A3}, R^{A4}, R^{A5}, R^{A6}, and R^{A7} are independently C₁-C₆ alkyl or siloxy. Preferably R^{A3}, R^{A4}, R^{A5}, R^{A6}, and R^{A7} are independently selected from methyl, ethyl, n-propyl, n-butyl, and trimethylsiloxy. More preferably, R^{A3}, R^{A4}, R^{A5}, R^{A6}, and R^{A7} are independently selected from methyl, n-butyl, and trimethylsiloxy.

D-9. Compounds of formulae D, D-1, D-2, D-3, D-4, D-5, D-6, and D-7 may include compounds of formula D-9, which are compounds of formula D, D-1, D-2, D-3, D-4, D-5, D-6, or D-7 wherein R^{A3} and R^{A4} are independently C₁-C₆ alkyl (e.g., methyl or ethyl) or siloxy (e.g., trimethylsiloxy), and R^{A5}, R^{A6}, and R^{A7} are independently C₁-C₆ alkyl (e.g., methyl, ethyl, n-propyl, or n-butyl).

Formula E. The silicone-containing component for use in the invention may comprise a multi-functional silicone-containing component. Thus, for example, the silicone-containing component of formula A may comprise a bifunctional material of formula E:

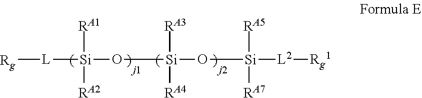

wherein

Rg, L, j1, j2, R^{A1}, R^{A2}, R^{A3}, R^{A4}, R^{A5}, and R^{A7} are as defined above for formula B or its various sub-formulae (e.g., B-1, B-2, etc.);

L² is a linking group; and

Rg¹ is a polymerizable group.

E-1. Compounds of formula E may include compounds of formula E-1, which are compounds of formula E wherein Rg and Rg¹ are each a vinyl carbonate of structure CH₂═CH—O—C(═O)—O— or structure CH₂═C(CH₃)—O—C(═O)—O—.

E-2. Compounds of formula E may include compounds of formula E-2, which are compounds of formula E wherein Rg and Rg¹ are each (meth)acrylate.

E-3. Compounds of formula E may include compounds of formula E-3, which are compounds of formula E wherein Rg and Rg¹ are each (meth)acrylamide, wherein the nitrogen group may be substituted with R^{A9} (wherein R^{A9} is as defined above).

E-4. Suitable compounds of formulae E, E-1, E-2, and E-3 include compounds of formula E-4, which are compounds of formula E, E-1, E-2, or E-3 wherein j1 is zero and j2 is from 1 to 220, or j2 is from 1 to 100, or j2 is from 1 to 50, or j2 is from 1 to 20.

E-5. Suitable compounds of formulae E, E-1, E-2, and E-3 include compounds of formula E-5, which are compounds of formula E, E-1, E-2, or E-3, wherein j1 and j2 are independently from 4 to 100.

E-6. Suitable compounds of formulae E, E-1, E-2, E-3, E-4, and E-5 include compounds of formula E-6, which are compounds of formula E, E-1, E-2, E-3, E-4, or E-5 wherein R^{A1}, R^{A2}, R^{A3}, R^{A4}, and R^{A5} are independently at each occurrence C₁-C₆ alkyl, preferably they are independently C₁-C₃ alkyl, or preferably, each is methyl.

E-7. Suitable compounds of formulae E, E-1, E-2, E-3, E-4, E-5, and E-6 include compounds of formula E-7, which are compounds of formula E, E-1, E-2, E-3, E-4, E-5, or E-6 wherein R^{A7} is alkoxy-alkyleneoxy-alkyl, preferably it is a methoxy capped polyethyleneoxyalkyl of formula CH₃O—[CH₂CH₂O]p-CH₂CH₂CH₂, wherein p is a whole number from 1 to 50, or from 1 to 30, or from 1 to 10, or from 6 to 10.

E-8. Suitable compounds of formulae E, E-1, E-2, E-3, E-4, E-5, E-6, and E-7 include compounds of formula E-8, which are compounds of formula E, E-1, E-2, E-3, E-4, E-5, E-6, or E-7 wherein L comprises alkylene, carbamate, siloxanyl, cycloalkylene, amide, haloalkyleneoxy, oxaalkylene, or combinations of two or more thereof, wherein the linking group is optionally substituted with one or more substituents independently selected from alkyl, hydroxyl, ether, amine, carbonyl, and carbamate.

E-9. Suitable compounds of formulae E, E-1, E-2, E-3, E-4, E-5, E-6, E-7, and E-8 include compounds of formula E-9, which are compounds of formula E, E-1, E-2, E-3, E-4, E-5, E-6, E-7, or E-8 wherein L² comprises alkylene, carbamate, siloxanyl, cycloalkylene, amide, haloalkyleneoxy, oxaalkylene, or combinations of two or more thereof, wherein the linking group is optionally substituted with one or more substituents independently selected from alkyl, hydroxyl, ether, amine, carbonyl, and carbamate.

Examples of silicone-containing components suitable for use in the invention include, but are not limited to, compounds listed in Table A. Where the compounds in Table A contain polysiloxane groups, the number of SiO repeat units in such compounds, unless otherwise indicated, is preferably from 3 to 100, more preferably from 3 to 40, or still more preferably from 3 to 20.

TABLE A

| | |
|---|---|
| 1 | mono-methacryloxypropyl terminated mono-n-butyl terminated polydimethylsiloxanes |
| | (mPDMS) (preferably containing from 3 to 15 SiO repeating units) |
| 2 | mono-acryloxypropyl terminated mono-n-butyl terminated polydimethylsiloxane |
| 3 | mono(meth)acryloxypropyl terminated mono-n-methyl terminated |
| | polydimethylsiloxane |
| 4 | mono(meth)acryloxypropyl terminated mono-n-butyl terminated polydiethylsiloxane |
| 5 | mono(meth)acryloxypropyl terminated mono-n-methyl terminated polydiethylsiloxane |
| 6 | mono(meth)acrylamidoalkylpolydialkylsiloxanes |
| 7 | mono(meth)acryloxyalkyl terminated mono-alkyl polydiarylsiloxanes |
| 8 | 3-methacryloxypropyltris(trimethylsiloxy)silane (TRIS) |
| 9 | 3-methacryloxypropylbis(trimethylsiloxy)methylsilane |
| 10 | 3-methacryloxypropylpentamethyl disiloxane |
| 11 | mono(meth)acrylamidoalkylpolydialkylsiloxanes |
| 12 | mono(meth)acrylamidoalkyl polydimethylsiloxanes |
| 13 | N-(2,3-dihydroxypropane)-N’-(propyl tetra(dimethylsiloxy) |
| | dimethylbutylsilane)acrylamide |
| 14 | 3-acrylamidopropyl tri(trimethylsiloxy)silane (TRIS-Am) |
| 15 | 2-hydroxy-3-[3-methyl-3,3-di(trimethylsiloxy)silylpropoxy]-propyl methacrylate |
| | (SiMAA) |
| 16 | 2-hydroxy-3-methacryloxypropyloxypropyl-tris(trimethylsiloxy)silane |
| 17 | mono-(2-hydroxy-3-methacryloxypropyl)-propyl ether terminated mono-n-butyl |
| | terminated polydimethylsiloxanes (OH-mPDMS) (containing from 4 to 30, or from 10 |
| | to 20, or from 4 to 8 SiO repeat units) |
| 18 | 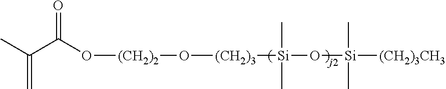 |
| 19 | 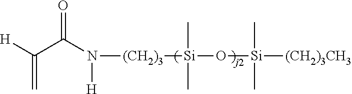 |
| 20 | 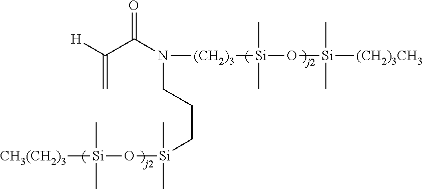 |
| 21 | 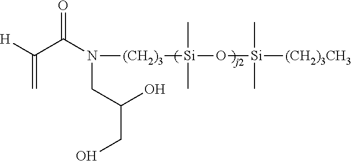 |
| 22 | 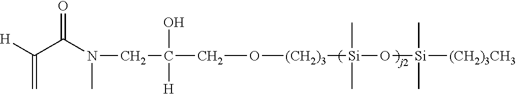 |
| 23 | 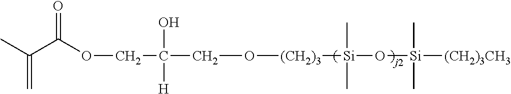 |
| 24 | 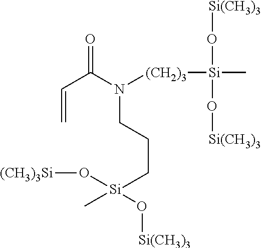 |

Additional non-limiting examples of suitable silicone-containing components are listed in Table B. Unless otherwise indicated, j2 where applicable is preferably from 1 to 100, more preferably from 3 to 40, or still more preferably from 3 to 15. In compounds containing j1 and j2, the sum of j1 and j2 is preferably from 2 to 100, more preferably from 3 to 40, or still more preferably from 3 to 15.

TABLE B

| | |
|---|---|
| 25 | 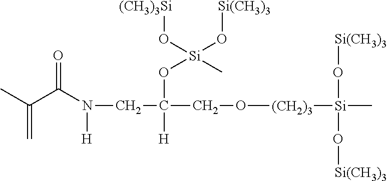 |
| 26 | 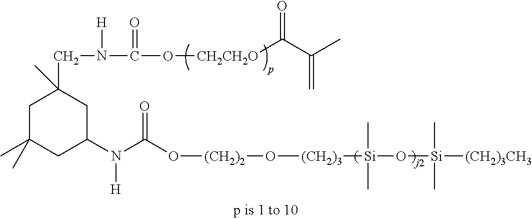 |
| 27 | 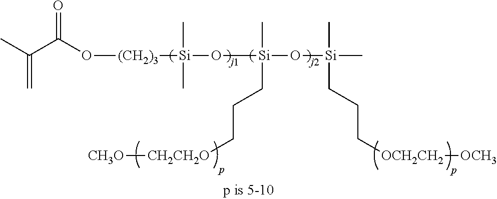 |
| 28 | 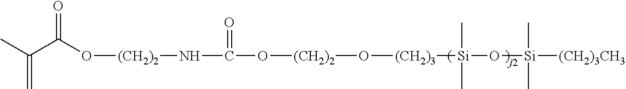 |
| 29 | 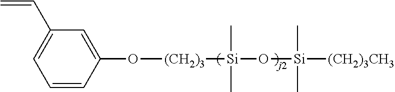 |
| 30 | 1,3-bis[4-(vinyloxycarbonyloxy)but-1-yl]tetramethyl-disiloxane |
| 31 | 3-(vinyloxycarbonylthio) propyl-[tris (trimethylsiloxy)silane] |
| 32 | 3-[tris(trimethylsiloxy)silyl] propyl allyl carbamate |
| 33 | 3-[tris(trimethylsiloxy)silyl] propyl vinyl carbamate |
| 34 | tris(trimethylsiloxy)silylstyrene (Styryl-TRIS) |
| 35 | 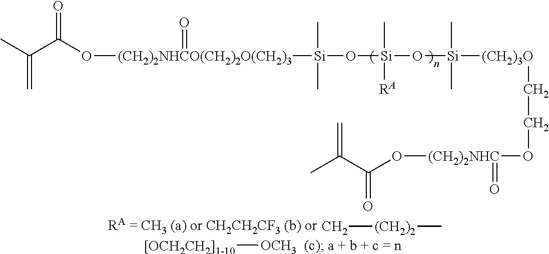 |
| 36 | 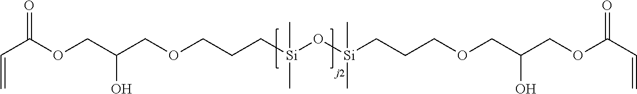 |
| 37 | 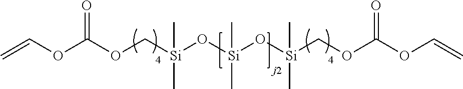 |
| 38 | 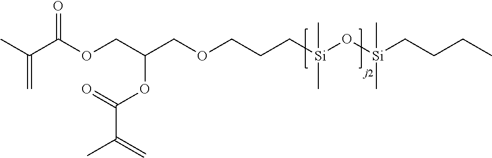 |
| 39 | 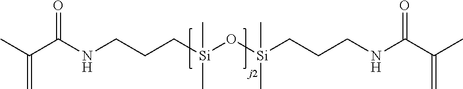 |
| 40 | 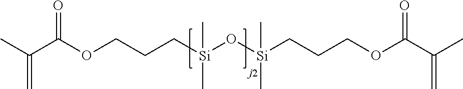 |
| 41 | 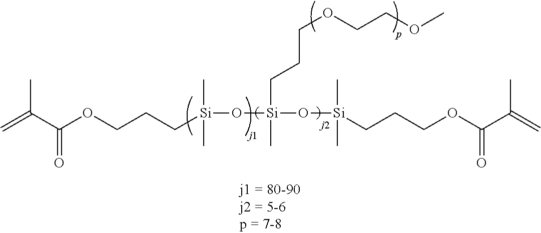 |
| 42 | 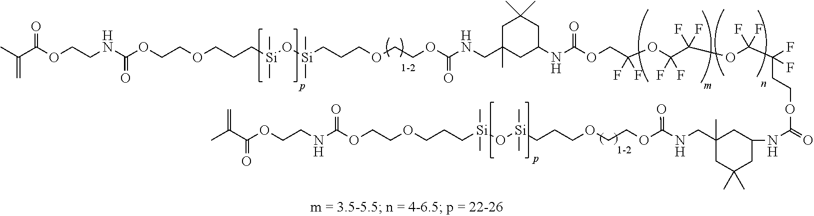 |
| 43 | 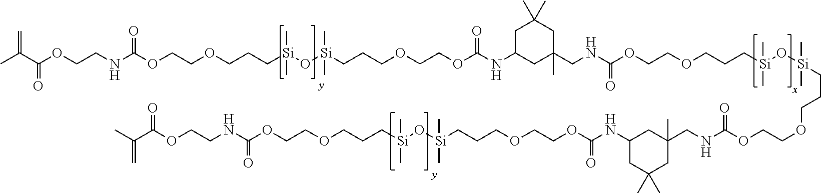 |

IEM-PDMS(Mn = 3000)-IPDI-PDMS(Mn = 2000)-IPDI-PDMS(Mn = 3000)-IEM (see WO2016100457)

The ethylenically unsaturated compound for inclusion in the first reactive composition and/or the grafting composition may comprise an independently selected hydrophilic component. Hydrophilic components include those which are capable of providing at least about 20% or at least about 25% water content to the resulting composition when combined with the remaining reactive components. Suitable hydrophilic components include hydrophilic monomers, prepolymers and polymers. Preferably, the hydrophilic component has at least one polymerizable group and at least one hydrophilic functional group. Examples of polymerizable groups include acrylic, methacrylic, acrylamido, methacrylamido, fumaric, maleic, styryl, isopropenylphenyl, O-vinylcarbonate, O-vinylcarbamate, allylic, O-vinylacetyl and N-vinyllactam and N-vinylamido double bonds.

The term “vinyl-type” or “vinyl-containing” monomers refer to monomers containing the vinyl grouping (—CH═CH₂) and are generally highly reactive. Such hydrophilic vinyl-containing monomers are known to polymerize relatively easily.

“Acrylic-type” or “acrylic-containing” monomers are those monomers containing an acrylic group (CH₂═CRCOX) wherein R is H or CH₃, and X is O or N, which are also known to polymerize readily, such as N,N-dimethyl acrylamide (DMA), 2-hydroxyethyl methacrylamide, polyethyleneglycol monomethacrylate, methacrylic acid, acrylic acid, mixtures thereof and the like.

Hydrophilic monomers with at least one hydroxyl group (hydroxyalkyl monomer) may be used. The hydroxyl alkyl group may be selected from C₂-C₄ mono or dihydroxy substituted alkyl, and poly(ethylene glycol) having 1-10 repeating units; or is selected from 2-hydroxyethyl, 2,3-dihydroxypropyl, or 2-hydroxypropyl, and combinations thereof.

Examples of hydroxyalkyl monomers include 2-hydroxyethyl (meth)acrylate, 3-hydroxypropyl (meth)acrylate, 2-hydroxypropyl (meth)acrylate, 2,3-dihydroxypropyl (meth)acrylate, 2-hydroxybutyl (meth)acrylate, 3-hydroxybutyl (meth)acrylate, 1-hydroxypropyl 2-(meth)acrylate, 2-hydroxy-2-methyl-propyl (meth)acrylate, 3-hydroxy-2,2-dimethyl-propyl (meth)acrylate, 4-hydroxybutyl (meth)acrylate, 2-hydroxyethyl (meth)acrylamide, N-(2-hydroxypropyl) (meth)acrylamide, N,N-bis(2-hydroxyethyl) (meth)acrylamide, N,N-bis(2-hydroxypropyl) (meth)acrylamide, N-(3-hydroxypropyl) (meth)acrylamide, 2,3-dihydroxypropyl (meth)acrylamide, glycerol (meth)acrylate, polyethyleneglycol monomethacrylate, and mixtures thereof.

The hydroxyalkyl monomer may also be selected from the group consisting of 2-hydroxyethyl methacrylate, glycerol methacrylate, 2-hydroxypropyl methacrylate, hydroxybutyl methacrylate, 3-hydroxy-2,2-dimethyl-propyl methacrylate, and mixtures thereof.

The hydroxyalkyl monomer may comprise 2-hydroxyethyl methacrylate, 3-hydroxy-2,2-dimethyl-propyl methacrylate, hydroxybutyl methacrylate or glycerol methacrylate.

When hydrophilic polymers in quantities great than about 3 wt % are desired, hydroxyl containing (meth)acrylamides are generally too hydrophilic to be included as compatibilizing hydroxyalkyl monomers, and hydroxyl containing (meth)acrylates may be included in the reactive composition and the lower amount of hydroxyalkyl monomers may be selected to provide a haze value to the final lens of less than about 50% or less than about 30%.

It will be appreciated that the amount of hydroxyl component will vary depending upon a number of factors, including, the number of hydroxyl groups on the hydroxyalkyl monomer, the amount, molecular weight and presence of hydrophilic functionality on the silicone containing components. The hydrophilic hydroxyl component may be present in the reactive composition in amounts up to about 15%, up to about 10 wt %, between about 3 and about 15 wt % or about 5 and about 15 wt %.

Hydrophilic vinyl-containing monomers which may be incorporated into the polymer compositions include monomers such as hydrophilic N-vinyl lactam and N-vinyl amide monomers including: N-vinyl pyrrolidone (NVP), N-vinyl-2-piperidone, N-vinyl-2-caprolactam, N-vinyl-3-methyl-2-caprolactam, N-vinyl-3-methyl-2-piperidone, N-vinyl-4-methyl-2-piperidone, N-vinyl-4-methyl-2-caprolactam, N-vinyl-3-ethyl-2- pyrrolidone, N-vinyl-4,5-dimethyl-2-pyrrolidone, N-vinyl acetamide (NVA), N-vinyl-N-methylacetamide (VMA), N-vinyl-N-ethyl acetamide, N-vinyl-N-ethyl formamide, N-vinyl formamide, N-vinyl-N-methylpropionamide, N-vinyl-N-methyl-2-methylpropionamide, N-vinyl-2-methylpropionamide, N-vinyl-N,N′-dimethylurea, 1-methyl-3-methylene-2-pyrrolidone, 1-methyl-5-methylene-2-pyrrolidone, 5-methyl-3-methylene-2-pyrrolidone; 1-ethyl-5-methylene-2-pyrrolidone, N-methyl-3-methylene-2-pyrrolidone, 5-ethyl-3-methylene-2-pyrrolidone, 1-N-propyl-3-methylene-2-pyrrolidone, 1-N-propyl-5-methylene-2-pyrrolidone, 1-isopropyl-3-methylene-2-pyrrolidone, 1-isopropyl-5-methylene-2-pyrrolidone, N-vinyl-N-ethyl acetamide, N-vinyl-N-ethyl formamide, N-vinyl formamide, N-vinyl isopropylamide, N-vinyl caprolactam, N-carboxyvinyl-β-alanine (VINAL), N-carboxyvinyl-a-alanine, N-vinylimidazole, and mixtures thereof.

Hydrophilic O-vinyl carbamates and O-vinyl carbonates monomers that may be used in the invention include: N-2-hydroxyethyl vinyl carbamate and N-carboxy-B-alanine N-vinyl ester. Further examples of the hydrophilic vinyl carbonate or vinyl carbamate monomers are disclosed in U.S. Pat. No. 5,070,215, and the hydrophilic oxazolone monomers are disclosed in U.S. Pat. No. 4,910,277.

Examples of vinyl carbamates and carbonates that may be used include: N-2-hydroxyethyl vinyl carbamate, N-carboxy-B-alanine N-vinyl ester, other hydrophilic vinyl monomers, including vinylimidazole, ethylene glycol vinyl ether (EGVE), di(ethylene glycol) vinyl ether (DEGVE), allyl alcohol, 2-ethyl oxazoline, vinyl acetate, acrylonitrile, and mixtures thereof.

(Meth)acrylamide monomers may also be used as hydrophilic monomers. Examples include N-N-dimethylacrylamide, acrylamide, N,N-bis(2-hydroxyethyl)acrylamide, acrylonitrile, N-isopropyl acrylamide, N,N-dimethylaminopropyl(meth)acrylamide, and any of the hydroxyl functional (meth)acrylamides listed above.

The hydrophilic monomers which may be incorporated into the polymers disclosed herein may be selected from N,N-dimethyl acrylamide (DMA), 2-hydroxyethyl acrylamide, 2-hydroxyethyl methacrylamide, N-hydroxypropyl methacrylamide, bishydroxyethyl acrylamide, 2,3-dihydroxypropyl (meth)acrylamide, N-vinylpyrrolidone (NVP), N-vinyl-N-methyl acetamide, N-vinyl methacetamide (VMA), and polyethyleneglycol monomethacrylate.

The hydrophilic monomers may be selected from DMA, NVP, VMA, NVA, and mixtures thereof.

The hydrophilic monomers may be macromers of linear or branched poly(ethylene glycol), poly(propylene glycol), or statistically random or block copolymers of ethylene oxide and propylene oxide. The macromer of these polyethers has one polymerizable group. Non-limiting examples of such polymerizable groups are acrylates, methacrylates, styrenes, vinyl ethers, acrylamides, methacrylamides, and other vinyl compounds. The macromer of these polyethers may comprise acrylates, methacrylates, acrylamides, methacrylamides, and mixtures thereof. Other suitable hydrophilic monomers will be apparent to one skilled in the art.

The hydrophilic monomers may also comprise charged monomers including but not limited to acrylic acid, methacrylic acid, 3-acrylamidopropionic acid (ACA1), 4-acrylamidobutanoic acid, 5-acrylamidopentanoic acid (ACA2), 3-acrylamido-3-methylbutanoic acid (AMBA), N-vinyloxycarbonyl-α-alanine, N-vinyloxycarbonyl-β-alanine (VINAL), 2-vinyl-4,4-dimethyl-2-oxazolin-5-one (VDMO), reactive sulfonate salts, including, sodium-2-(acrylamido)-2-methylpropane sulphonate (AMPS), 3-sulphopropyl (meth)acrylate potassium salt, 3-sulphopropyl (meth)acrylate sodium salt, bis 3- sulphopropyl itaconate di sodium, bis 3-sulphopropyl itaconate di potassium, vinyl sulphonate sodium salt, vinyl sulphonate salt, styrene sulfonate, sulfoethyl methacrylate, combinations thereof and the like.

The hydrophilic monomers may be selected from N, N-dimethyl acrylamide (DMA), N-vinylpyrrolidone (NVP), 2-hydroxyethyl methacrylate (HEMA), N-vinyl methacetamide (VMA), and N-vinyl N-methyl acetamide (NVA), N-hydroxypropyl methacrylamide, mono-glycerol methacrylate, 2-hydroxyethyl acrylamide, 2-hydroxyethyl methacrylamide, bishydroxyethyl acrylamide, 2,3-dihydroxypropyl (meth)acrylamide and mixtures thereof.

The hydrophilic monomers may be selected from DMA, NVP, HEMA, VMA, NVA, and mixtures thereof.

The hydrophilic monomer(s) (including the hydroxyl alkyl monomers) may be present in amounts up to about 60 wt %, from about 1 to about 60 weight %, from about 5 to about 50 weight %, or from about 5 to about 40 weight %, based upon the weight of all reactive components.

Other hydrophilic monomers that can be employed include polyoxyethylene polyols having one or more of the terminal hydroxyl groups replaced with a polymerizable group. Examples include polyethylene glycol with one or more of the terminal hydroxyl groups replaced with a polymerizable group. Examples include polyethylene glycol reacted with one or more molar equivalents of an end-capping group such as isocyanatoethyl methacrylate (“IEM”), methacrylic anhydride, methacryloyl chloride, vinylbenzoyl chloride, or the like, to produce a polyethylene polyol having one or more terminal polymerizable olefinic groups bonded to the polyethylene polyol through linking moieties such as carbamate or ester groups.

Still further examples are the hydrophilic vinyl carbonate or vinyl carbamate monomers disclosed in U.S. Pat. No. 5,070,215, and the hydrophilic oxazolone monomers disclosed in U.S. Pat. No. 4,190,277. Other suitable hydrophilic monomers will be apparent to one skilled in the art.

Hydrophilic monomers which may be incorporated into the polymer compositions disclosed herein include hydrophilic monomers such as N,N-dimethyl acrylamide (DMA), 2-hydroxyethyl acrylate, glycerol methacrylate, 2-hydroxyethyl methacrylamide, N-vinylpyrrolidone (NVP), N-vinyl methacrylamide, HEMA, and poly(ethyleneglycol) methyl ether methacrylate (mPEG).

Hydrophilic monomers may include DMA, NVP, HEMA and mixtures thereof.

The first reactive composition and/or the grafting composition may contain one or more independently selected ethylenically unsaturated zwitterionic compounds, such as an ethylenically unsaturated betaine. Preferably, the zwitterionic compound is in the grafting composition. Examples of suitable compounds include: N-(2-carboxyethyl)-N,N-dimethyl-3-[(1-oxo-2-propen-1-yl)amino]-1-propanaminium, inner salt (CAS 79704-35-1, also known as 3-acrylamido-N-(2-carboxyethyl)-N,N-dimethylpropane-1-aminium or CBT); 3-methacrylamido-N-(2-carboxyethyl)-N,N-dimethylpropane-1-aminium; N,N-dimethyl-N-[3-[(1-oxo-2-propen-1-yl)amino]propyl]-3-sulfo-1-propanaminium, inner salt (CAS 80293-60-3, also known as 3-((3-acrylamidopropyl) dimethylammonio) propane-1-sulfonate or SBT); 3-((3-methacrylamidopropyl) dimethylammonio) propane-1-sulfonate; 3,5-Dioxa-8-aza-4-phosphaundec-10-en-1-aminium, 4-hydroxy-N,N,N-trimethyl-9-oxo, inner salt, 4-oxide (CAS 163674-35-9, “PBT”); 2-(acrylamidoethoxy)-(2-(trimethylammonio)ethyl) phosphate; 2-(methacrylamidoethoxy)-(2-(trimethylammonio)ethyl) phosphate; 4-hydroxy-N,N,N,10-tetramethyl-9-oxo-3,5,8-trioxa-4-phosphaundec-10-en-1-aminium inner salt, 4-oxide (CAS 67881-98-5, also known as 2-(methacryloyloxy)ethyl (2-(trimethylammonio)ethyl) phosphate or MPC); or 2-(acryloyloxy)ethyl (2-(trimethylammonio)ethyl) phosphate.

The first reactive composition and/or the grafting composition may contain one or more independently selected ethylenically unsaturated quaternary ammonium salts. Preferably, the quaternary ammonium salt is in the grafting composition. Examples of suitable compounds include 2-(methacryloyloxy)ethyl trimethylammonium chloride; 2-(acryloyloxy)ethyl trimethylammonium chloride; 3-methacrylamido-N,N,N-trimethylpropan-1-aminium chloride; or 3-acrylamido-N,N,N-trimethylpropan-1-aminium chloride

The first reactive composition and/or the grafting composition may contain one or more independently selected ethylenically unsaturated active pharmaceutical ingredients. Preferably, the active pharmaceutical compound is in the grafting composition. Examples of suitable compounds include cyclosporine or salicylate monomers.

The first reactive composition and/or the grafting composition may contain one or more independently selected ethylenically unsaturated peptides. Preferably, the peptide is in the grafting composition. Exemplary compounds include, for instance, those wherein the amino-terminus of a peptide may be acylated with an acylating agent such as (meth)acryloyl chloride, (meth)acrylic anhydride, isopropenyl α,α-dimethylbenzyl isocyanate and 2-isocyanatoethyl methacrylate along with known co-reagents and catalysts to form a monomer suitable for incorporation into reactive compositions of the present inventions

The first reactive composition of the invention contains a crosslinker. Crosslinkers may optionally be present in the grafting composition. A variety of crosslinkers may be used, including silicone-containing and non-silicone containing cross-linking agents, and mixtures thereof. Examples of suitable crosslinkers include ethylene glycol dimethacrylate (EGDMA), diethyleneglycol dimethacrylate, trimethylolpropane trimethacrylate (TMPTMA), tetraethylene glycol dimethacrylate (TEGDMA), triallyl cyanurate (TAC), glycerol trimethacrylate, 1,3-propanediol dimethacrylate; 2,3-propanediol dimethacrylate; 1,6-hexanediol dimethacrylate; 1,4-butanediol dimethacrylate, methacryloxyethyl vinylcarbonate (HEMAVc), allylmethacrylate, methylene bisacrylamide (MBA), polyethylene glycol dimethacrylate (wherein the polyethylene glycol preferably has a molecular weight up to 5,000 Daltons). The crosslinkers are used in the typical amounts known to those skilled in the art, e.g., from about 0.000415 to about 0.0156 mole per 100 grams of reactive components in the reaction composition.

If the ethylenically unsaturated compound, such as a hydrophilic monomer or a silicone containing monomer, acts as the crosslinker, for instance by virtue of being bifunctional or multifunctional, the addition of a separate crosslinker to the reaction composition is optional. In this case, the ethylenically unsaturated compound is also considered a crosslinker. Examples of hydrophilic monomers which can act as the crosslinking agent and when present do not require the addition of an additional crosslinking agent to the reaction composition include polyoxyethylene polyols described above containing two or more terminal methacrylate moieties. An example of a silicone containing monomer which can act as a crosslinking agent and, when present, does not require the addition of a crosslinking monomer to the reaction composition includes α, ω-bismethacryloypropyl polydimethylsiloxane. In addition, any of the above disclosed multifunctional silicone-containing components may be used as cross-linking agents.

Either or both of the first reactive composition and the grafting composition may contain additional components such as, but not limited to, UV absorbers, high energy visible light (HEV) absorbers, photochromic compounds, pharmaceutical and nutraceutical compounds, antimicrobial compounds, reactive tints, pigments, copolymerizable and non-polymerizable dyes, release agents and combinations thereof. Other components that can be present in the first and/or grafting compositions include wetting agents, such as those disclosed in U.S. Pat. No. 6,367,929, WO03/22321, WO03/22322, compatibilizing components, such as those disclosed in US2003/162862 and US2003/125498. The sum of additional components may be up to about 20 wt %. The reactive compositions may comprise up to about 18 wt % wetting agent, or from about 5 and about 18 wt % wetting agent.

As used herein, wetting agents are hydrophilic polymers having a weight average molecular weight greater than about 5,000 Daltons, between about 150,000 Daltons to about 2,000,000 Daltons; between about 300,000 Daltons to about 1,800,000 Daltons; or between about 500,000 Daltons to about 1,500,000 Daltons.

The amount of optional wetting agent which may be added to the first reactive composition and/or the grafting composition of the present invention may be varied depending on the other components used and the desired properties of the resulting product. When present, the internal wetting agents in reactive compositions may be included in amounts from about 1 weight percent to about 20 weight percent; from about 2 weight percent to about 15 percent, or from about 2 to about 12 percent, all based upon the total weight of all of the reactive components. Preferably, a wetting agent, when used, is present in the first reactive composition.

Wetting agents include but are not limited to homopolymers, statistically random copolymers, diblock copolymers, triblock copolymers, segmented block copolymers, graft copolymers, and mixtures thereof. Non-limiting examples of internal wetting agents are polyamides, polyesters, polylactones, polyimides, polylactams, polyethers, polyacids homopolymers and copolymers prepared by the free radical polymerization of suitable monomers including acrylates, methacrylates, styrenes, vinyl ethers, acrylamides, methacrylamides, N-vinyllactams, N-vinylamides, O-vinylcarbamates, O-vinylcarbonates, and other vinyl compounds. The wetting agents may be made from any hydrophilic monomer, including those listed herein.

The wetting agents may include acyclic polyamides that comprise pendant acyclic amide groups and are capable of association with hydroxyl groups. Cyclic polyamides comprise cyclic amide groups and are also capable of association with hydroxyl groups.

Examples of suitable acyclic polyamides include polymers and copolymers comprising repeating units of Formula XXIX or Formula XXX:

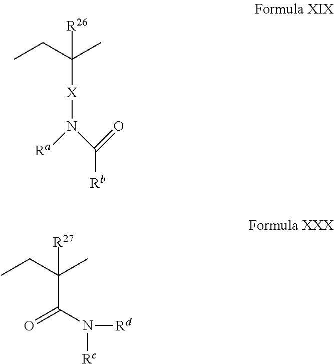

wherein X is a direct bond, —(CO)—, or —(CO)—NHR^{e}—, wherein R²⁶ and R²⁷ are H or methyl groups; wherein R^{e} is a C₁ to C₃ alkyl group; R^{a} is selected from H, straight or branched, substituted or unsubstituted C₁ to C₄ alkyl groups; R^{b} is selected from H, straight or branched, substituted or unsubstituted C₁ to C₄ alkyl groups, amino groups having up to two carbon atoms, amide groups having up to four carbon atoms, and alkoxy groups having up to two carbon groups; R^{c} is selected from H, straight or branched, substituted or unsubstituted C₁ to C₄ alkyl groups, or methyl, ethoxy, hydroxyethyl, and hydroxymethyl; R^{d} is selected from H, straight or branched, substituted or unsubstituted C₁ to C₄ alkyl groups; or methyl, ethoxy, hydroxyethyl, and hydroxymethyl wherein the number of carbon atoms in R^{a} and R^{b} taken together is 8 or less, including 7, 6, 5, 4, 3, or less, and wherein the number of carbon atoms in R^{c} and R^{d} taken together is 8 or less, including 7, 6, 5, 4, 3, or less. The number of carbon atoms in R^{a} and R^{b} taken together may be 6 or less or 4 or less. The number of carbon atoms in R^{c} and R^{d} taken together may be 6 or less. As used herein substituted alkyl groups include alkyl groups substituted with an amine, amide, ether, hydroxyl, carbonyl, carboxy groups or combinations thereof.

R^{a} and R^{b} can be independently selected from H, substituted or unsubstituted C₁ to C₂ alkyl groups. X may be a direct bond, and R^{a} and R^{b} may be independently selected from H, substituted or unsubstituted C₁ to C₂ alkyl groups.

R^{c} and R^{d} can be independently selected from H, substituted or unsubstituted C₁ to C₂ alkyl groups, methyl, ethoxy, hydroxyethyl, and hydroxymethyl.

The acyclic polyamides of the present invention may comprise a majority of the repeating unit of Formula XXIX or Formula XXX, or the acyclic polyamides can comprise at least about 50 mole % of the repeating unit of Formula XXIX or Formula XXX, including at least about 70 mole %, and at least 80 mole %.

Specific examples of repeating units of Formula XXIX or Formula XXX include repeating units derived from N-vinyl-N-methylacetamide, N-vinylacetamide, N-vinyl-N-methylpropionamide, N-vinyl-N-methyl-2-methylpropionamide, N-vinyl-2-methylpropionamide, N-vinyl-N,N′-dimethylurea, N, N-dimethylacrylamide, methacrylamide and acyclic amides of Formulae XXXI and XXXII:

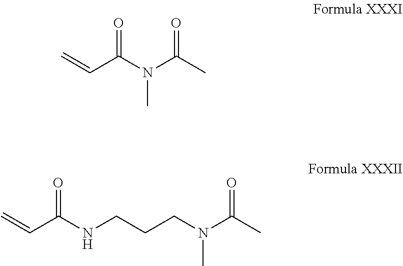

Examples of suitable cyclic amides that can be used to form the cyclic polyamides include α-lactam, β-lactam, γ-lactam, δ-lactam, and ε-lactam. Examples of suitable cyclic polyamides include polymers and copolymers comprising repeating units of Formula XXXIII:

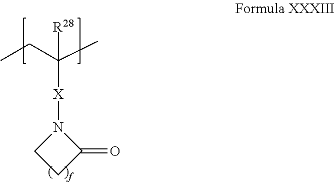

wherein f is a number from 1 to 10, X is a direct bond, —(CO)—, or —(CO)—NH—R^{e}—, wherein R^{e} is a C₁ to C₃ alkyl group and R²⁸ is a hydrogen atom or methyl group. In Formula XXXIII, f may be 8 or less, including 7, 6, 5, 4, 3, 2, or 1. In Formula XXXIII, f may be 6 or less, including 5, 4, 3, 2, or 1, or may be from 2 to 8, including 2, 3, 4, 5, 6, 7, or 8, or may be 2 or 3.

When X is a direct bond, f may be 2. In such instances, the cyclic polyamide may be polyvinylpyrrolidone (PVP).

The cyclic polyamides may comprise 50 mole % or more of the repeating unit of Formula XXXIII, or the cyclic polyamides can comprise at least about 50 mole % of the repeating unit of Formula XXXIII, including at least about 70 mole %, and at least about 80 mole %.

Specific examples of repeating units of Formula XXXIII include repeating units derived from N-vinylpyrrolidone, which forms PVP homopolymers and vinylpyrrolidone copolymers or N-vinylpyrrolidone substituted with hydrophilic substituents such as phosphoryl choline.

The polyamides may also be copolymers comprising cyclic amide, acyclic amide repeating units or copolymers comprising both cyclic and acyclic amide repeating units. Additional repeating units may be formed from monomers selected from hydroxyalkyl(meth)acrylates, alkyl(meth)acrylates or other hydrophilic monomers and siloxane substituted acrylates or methacrylates. Any of the monomers listed as suitable hydrophilic monomers may be used as comonomers to form the additional repeating units. Specific examples of additional monomers which may be used to form polyamides include 2-hydroxyethylmethacrylate, vinyl acetate, acrylonitrile, hydroxypropyl methacrylate, 2-hydroxyethyl acrylate, methyl methacrylate and hydroxybutyl methacrylate, GMMA, PEGS, and the like and mixtures thereof. Ionic monomers may also be included. Examples of ionic monomers include acrylic acid, methacrylic acid, 2-methacryloyloxyethyl phosphorylcholine, 3-(dimethyl(4-vinylbenzyl)ammonio)propane-1-sulfonate (DMVBAPS), 3-((3-acrylamidopropyl)dimethylammonio)propane-1-sulfonate (AMPDAPS), 3-((3-methacrylamidopropyl)dimethylammonio)propane-1-sulfonate (MAMPDAPS), 3-((3-(acryloyloxy)propyl)dimethylammonio)propane-1-sulfonate (APDAPS), methacryloyloxy)propyl)dimethylammonio)propane-1-sulfonate (MAPDAPS).

The reactive composition may comprise both an acyclic polyamide and a cyclic polyamide or copolymers thereof. The acyclic polyamide can be any of those acyclic polyamides described herein or copolymers thereof, and the cyclic polyamide can be any of those cyclic polyamides described herein or copolymers thereof. The polyamide may be selected from the group polyvinylpyrrolidone (PVP), polyvinylmethyacetamide (PVMA), polydimethylacrylamide (PDMA), polyvinylacetamide (PNVA), poly(hydroxyethyl(meth)acrylamide), polyacrylamide, and copolymers and mixtures thereof.

The wetting agents may be made from DMA, NVP, HEMA, VMA, NVA, and combinations thereof. The wetting agents may also be reactive components, as defined herein, by having polymerizable groups, for example, made by the acylation reaction between pendant hydroxyl groups on HEMA repeating units of an internal wetting agent and methacryloyl chloride or methacryloyl anhydride. Other methods of functionalization will be apparent to one skilled in the art.

Such internal wetting agents are disclosed in U.S. Pat. Nos. 6,367,929, 6,822,016, 7,052,131, 7,666,921, 7,691,916, 7,786,185, 8,022,158, and 8,450,387.

Generally, the reactive components within a reactive composition may be dispersed or dissolved in a diluent. Suitable diluents are known in the art or can be easily determined by a person of ordinary skill in the art. For example, when silicone hydrogels are being prepared, suitable diluents are disclosed in WO 03/022321 and U.S. Pat. No. 6,020,445 the disclosures of which are incorporated herein by reference.

Classes of suitable diluents for silicone hydrogel reaction mixtures include alcohols having 2 to 20 carbons, amides having 10 to 20 carbon atoms derived from primary amines and carboxylic acids having 8 to 20 carbon atoms. Primary and tertiary alcohols are preferred. Preferred classes include alcohols having 5 to 20 carbons and carboxylic acids having 10 to 20 carbon atoms.

Specific diluents which may be used include 1-ethoxy-2-propanol, diisopropylaminoethanol, isopropanol, 3,7-dimethyl-3-octanol, 1-decanol, 1-dodecanol, 1-octanol, 1-pentanol, 2-pentanol, 1-hexanol, 2-hexanol, 2-octanol, 3-methyl-3-pentanol, tert-amyl alcohol, tert-butanol, 2-butanol, 1-butanol, 2-methyl-2-pentanol, 2-propanol, 1-propanol, ethanol, 2-ethyl-1-butanol, (3-acetoxy-2-hydroxypropyloxy)propylbis(trimethylsiloxy) methylsilane, 1-tert-butoxy-2-propanol, 3,3-dimethyl-2-butanol, tert-butoxyethanol, 2-octyl-1-dodecanol, decanoic acid, octanoic acid, dodecanoic acid, 2-(diisopropylamino)ethanol mixtures thereof and the like.

Preferred diluents include 3,7-dimethyl-3-octanol, 1-dodecanol, 1-decanol, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, 2-methyl-2-pentanol, 2-ethyl-1-butanol, ethanol, 3,3-dimethyl-2-butanol, 2-octyl-1-dodecanol, decanoic acid, octanoic acid, dodecanoic acid, mixtures thereof and the like.

More preferred diluents include 3,7-dimethyl-3-octanol, 1-dodecanol, 1-decanol, 1-octanol, 1-pentanol, 1-hexanol, 2-hexanol, 2-octanol, 1-dodecanol, 3-methyl-3-pentanol, 1-pentanol, 2-pentanol, t-amyl alcohol, tert-butanol, 2-butanol, 1-butanol, 2-methyl-2-pentanol, 2-ethyl-1-butanol, 3,3-dimethyl-2-butanol, 2-octyl-1-dodecanol, mixtures thereof and the like.

Suitable diluents for non-silicone containing reaction compositions include glycerin, ethylene glycol, ethanol, methanol, ethyl acetate, methylene chloride, polyethylene glycol, polypropylene glycol, low number average molecular weight polyvinylpyrrolidone (PVP), such as disclosed in U.S. Pat. Nos. 4,018,853, 4,680,336 and 5,039,459, including, but not limited to boric acid esters of dihydric alcohols, combinations thereof and the like.

Mixtures of diluents may be used. The diluents may be used in amounts up to about 55% by weight of the total of all components in the reactive composition. More preferably the diluent is used in amounts less than about 45% and more preferably in amounts between about 15 and about 40% by weight of the total of all components in the reactive composition.

In a preferred aspect, the crosslinked substrate network of the invention may be a silicone hydrogel (containing covalently bound activatable free radical initiators such as MAPO groups) and the grafting composition may provide, following polymerization, a hydrophilic grafted material (which may optionally be charged), for instance comprising poly(N,N-dimethylacrylamide) (PDMA), polymerized polyethylene glycol mono-methacrylate (e.g., having number average molecular weight from about 300 to about 1000) (poly(mPEG)), a copolymer of 2-hydroxyethyl methacrylate and methacrylic acid, 2-(methacryloyloxy)ethyl (2-(trimethylammonio)ethyl) phosphate (MPC). Such grafted polymer networks may exhibit improved biocompatibility and biometrics when used in ophthalmic devices.

The crosslinked substrate network may be a conventional hydrogel (e.g., comprising a copolymer of 2-hydroxyethyl methacrylate and methacrylic acid and containing MAPO groups) and the grafting composition provides, following polymerization, a hydrophilic grafted material (which may optionally be charged), such as a polyamide. Examples include PDMA, polyvinylpyrrolidone (PVP), poly(N-vinyl N-methyl acetamide) (PVMA), and copolymers thereof. Such grafted polymer networks may exhibit improved biocompatibility and biometrics, for instance when used in ophthalmic devices.

The crosslinked substrate network may be a conventional hydrogel (e.g., a copolymer of 2-hydroxyethyl methacrylate and methacrylic acid and containing MAPO groups) and the grafting composition provides, following polymerization, a hydrophobic siloxane containing material. Such grafted polymeric networks may exhibit desirable physical and mechanical properties, such as oxygen gas permeability (Dk) and modulus, as well as improved biocompatibility and handling.

For ophthalmic devices, such as contact lenses, that contain one or more silicone containing component, the silicone-containing component(s) may preferably be present in amounts up to about 95 weight %, or from about 10 to about 80, or from about 20 to about 70 weight %, based upon all reactive components present, including in the first reactive composition and the reactive second composition. Suitable hydrophilic components may preferably be present in amounts from about 10 to about 60 weight %, or from about 15 to about 50 weight %, or from about 20 to about 40 weight %, based upon all reactive components present, including in the first reactive composition and the grafting composition.

It should be noted that additional, optional, steps may be included in the process for making the polymer compositions of the invention. For instance, following step (b), an ink or dye may be added to the crosslinked substrate network. Then, the remaining steps (step (c) etc.) may be carried out. This allows for an ink or dye to be sandwiched within the grafted polymeric network.

Moreover, the ophthalmic device formed by the aforementioned process may be further modified by one or more chemical reactions between the grafted compositions and other reagents to introduce other functionality or to modify surface properties. For example, grafting poly(2-hydroxyethyl methacrylate) onto a crosslinked substrate network provides hydroxy groups that may be further reacted (e.g., by acylation reactions) with other molecules which provide additional features to the grafted composition and/or final article. Such molecules may be UV-VIS blockers, dyes, pigments, bioactive compounds like peptides, prodrugs, and the like. Grafting polyacrylic acid on a crosslinked substrate network provides carboxylate groups that may be further reacted (e.g., by active ester methodologies) with other molecules as already mentioned above. Moreover, in the case of a contact lens made from a silicone hydrogel as the crosslinked substrate network and then grafted with polyacrylic acid, polymethacrylic acid, poly(glycidyl methacrylate) or copolymers thereof, the resulting poly(acid/epoxy) coated or primed contact lens may be used in a variety of layer by layer coating techniques to modify the surface properties of the contact lens.

For ophthalmic devices, such as contact lenses, the crosslinked substrate network is preferably a silicone hydrogel with a balance of properties that makes them desirable. These properties include water content, haze, contact angle, modulus, oxygen permeability, lipid uptake, lysozyme uptake and PQ1 uptake. Examples of preferred properties are as follows. All values are prefaced by “about,” and the ophthalmic devices may have any combination of the listed properties:

Water content: at least 20%, or at least 25%

Haze: 30% or less, or 10% or less

Dynamic contact angle (DCA (°)): 100° or less, or 50° or less Modulus (psi): 120 or less, or 80 to 120

Oxygen permeability (Dk (barrers)): at least 80, or at least 100, or at least 150, or at least 200

Elongation to Break: at least 100

For ionic silicon hydrogels, the following properties may also be preferred (in addition to those recited above):

Lysozyme uptake (μg/lens): at least 100, or at least 150, or at least 500, or at least 700

Polyquaternium-1 (PQ1) uptake (%): 15 or less, or 10 or less, or 5 or less

Finished ophthalmic devices may be manufactured by various techniques. For instance, in the case of hydrogel contact lenses, the first reactive composition described above may be cured in a mold, or formed via spincasting or static casting. Spincasting methods are disclosed in U.S. Pat. Nos. 3,408,429 and 3,660,545, and static casting methods are disclosed in U.S. Pat. Nos. 4,113,224 and 4,197,266. In one embodiment, the contact lenses of this invention are formed by the direct molding of the hydrogels, which is economical, and enables precise control over the final shape of the hydrated contact lens. For this method, the first reactive composition is placed in a mold having the desired shape and the reactive composition is subjected to conditions as described above whereby the reactive components polymerize to produce the crosslinked substrate network in the approximate shape of the final desired product.

The crosslinked substrate network formed after such curing may be mechanically released from the mold. The crosslinked substrate network may then be immersed in the grafting composition (which may optionally contain a diluent), and sufficient time is allowed to permit at the reactive composition to diffuse into the crosslinked substrate network to the desired level. Thereafter, the suspension is irradiated to form the grafted product, and the contact lenses may then be extracted to remove unreacted components.

Extractions of the crosslinked substrate network and the contact lens may be done using conventional extraction fluids, such organic solvents, such as alcohols or may be extracted using aqueous solutions. Aqueous solutions are solutions which comprise water. The aqueous solutions may comprise at least about 30 weight % water, or at least about 50 weight % water, or at least about 70% water or at least about 90 weight % water. Exemplary solutions for aqueous extraction may include water (including deionized water), a phosphate buffer, a borate buffer, or a mixture of two or more thereof.

Extraction may be accomplished, for example, via immersion of the crosslinked substrate network or the contact lens in an aqueous solution or exposing the material to a flow of an aqueous solution. Extraction may also include, for example, one or more of: heating the aqueous solution; stirring the aqueous solution; increasing the level of release aid in the aqueous solution to a level sufficient to cause release of the crosslinked substrate network from the mold; mechanical or ultrasonic agitation; and incorporating at least one leach aid in the aqueous solution to a level sufficient to facilitate adequate removal of unreacted components from the crosslinked substrate network or the contact lens. The foregoing may be conducted in batch or continuous processes, with or without the addition of heat, agitation or both.

Some embodiments may also include the application of physical agitation to facilitate leach and release. For example, the crosslinked substrate network mold part to which the crosslinked substrate network is adhered may be vibrated or caused to move back and forth within an aqueous solution. Other embodiments may include ultrasonic waves through the aqueous solution.

Contact lenses may be sterilized by known means such as, but not limited to, autoclaving.

Some embodiments of the invention will now be described in detail in the following Examples.

### EXAMPLES

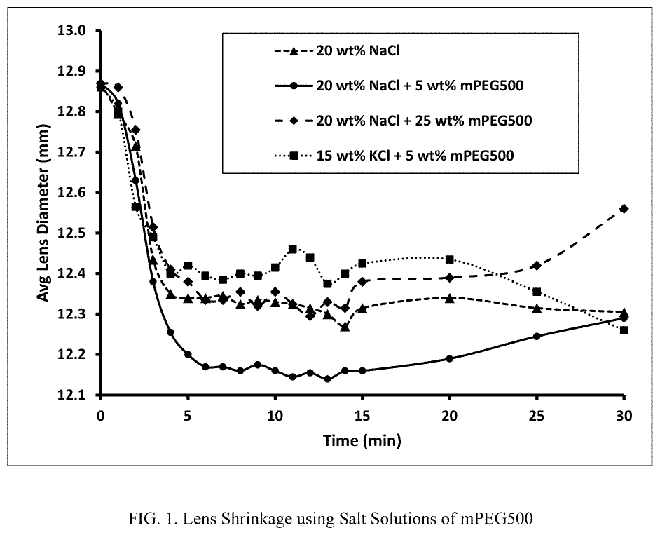

The contact lens diameter (DM) was measured on a calibrated Nikon Stereo Microscope using Nikon Elements analysis software. Calibration was done using a circular calibration measurement tool of known dimensions at a fixed magnification. The contact lens was placed concave side down into a crystal cell completely filled with the respective salt solutions listed in FIG. 1. A cap was placed onto the cell ensuring that no air is trapped underneath. The cell was then placed on the microscope stage, and the lens image brought into focus and the diameter was measured. The measurement was calibrated against a known standard. Typically, two diameter measurements are made and the average used in the graphs shown in FIG. 1.

Fourier Transform Infrared (FTIR) spectra were measured using a Thermo Scientific Nicolet iS50 instrument. Transmission FTIR spectra were measured by mounting the lens into the sample chamber so that the beam passed through the center of the lens, thereby yielding “bulk” or overall compositional information. Attenuated total reflectance (ATR) FTIR spectra were measured using a standard diamond ATR crystal (45° angle of incidence), thereby yielding “surface” compositional information. Peak height analysis was performed using the Thermo Scientific OMNIC™ software.

Sample Preparation: Prior to performing either transmission or ATR FTIR analysis, the test lenses are soaked in deuterated saline for 1 hour. Exchanging water for deuterium oxide shifts the water bands in the FTIR spectrum to provide a clear spectral region for observing the amide carbonyl region of the spectrum. Deuterated saline is prepared according to ISO-10344 using deuterium oxide instead of water. After removal from the deuterated saline, the test lens is analyzed by either transmission or ATR analysis. For transmission analysis, a 4 mm disk is cut from the center of the lens (thickness ˜100 μm) using a biopsy punch. The excised lens section is placed in a (2.5 mm) diamond compression cell and tightened to thin the sample and thereby allow transmission of the FTIR beam through the material. The degree of compression is such that the spectral peaks of interest have an intensity of less than 2 absorbance units. A beam condenser is used to create a narrow beam waist thereby allowing a larger portion of the FTIR beam to penetrate the sample. For ATR analysis the center of an uncut lens is placed on the diamond ATR crystal and held in place with a pressure clamp equipped with a digital force adapter to monitor the force applied (˜0.5 kgf).

Data Acquisition: Before analysis, a background scan was performed using either an empty compression cell or a clean ATR crystal without a lens sample. All contact lens spectra were corrected for these background absorbances using the usual correction procedure. Spectra were acquired by averaging 16 scans over the wavenumber range 400 to 4000 cm′ using a resolution of 4 cm′.

Infrared absorption bands were identified for the following functional groups: ester carbonyl at 1715 cm⁻¹ (corresponding methacrylate or acrylate), cyclic amide carbonyl at 1657 cm⁻¹ (corresponding to PVP), acyclic amide carbonyl at 1618 cm⁻¹ (corresponding to DMA), linear silicone at 796 cm⁻¹ (corresponding to mPDMS), phosphoryl group at 970 cm⁻¹ (corresponding to MPC), and ether CH₂ wagging at 1350 cm⁻¹ (corresponding to mPEG500). In general, an absorption band was chosen as an internal standard. For example, the acyclic amide carbonyl band at 1618 cm⁻¹ may be chosen, or the (meth)acrylate absorption band at 1715 cm⁻¹ may be chosen. Then, changes in concentration of a functional group as a surrogate for changes in concentration of a polymerized reactive monomer mixture component or a polymeric ingredient can be measured by comparing the ratios of band heights of the functional group (or component) band divided by the band height of the internal standard band from sample to sample. For example, the FTIR absorption band ratio of PVP to methacrylate (denoted in the figures as PVP/Methacrylate Band Ratio and representing molar ratios) can be used to compare the relative concentrations of PVP among samples. In the case of HEMA grafting, since grafted HEMA contributes far more to the methacrylate FTIR absorption band than the PVP signal, it was possible to use a reduction in the PVP/Methacrylate Band Ratio as indirect evidence of successful HEMA grafting.

Alternatively, by using a set of calibration standards with known concentrations of two polymerized reactive monomer mixture components, more precise quantitation can be achieved. For example, the FTIR absorption band ratios of mPEG500 to DMA was measured in a set of standards that contain various concentrations of mPEG500 in DMA. It was then possible to relate an observed change in the absorption band ratio of these two components with the associated change in concentration in the sample. Calibration curves of mPEG500 and MPC in DMA were developed so that the concentrations (weight percentages) of grafted mPEG500 and MPC on lenses (which contained DMA) could be measured.

The following abbreviations will be used throughout the Examples and have the following meanings:

### DMA: N, N-dimethylacrylamide (Jarchem)

HEMA: 2-hydroxyethyl methacrylate (Bimax or Evonik)
MAA: methacrylic acid (Acros)
MPC: 3,5,8-trioxa-4-phosphaundec-10-en-1-aminium, 4-hydroxy-N,N,N,10-tetramethyl-9-oxo, inner salt, 4-oxide; CAS 67881-98-5
mPEG500: polyethylene glycol methyl ether methacrylate (Aldrich) (Mₙ=500 g/mol)
PVP K90: poly(N-vinylpyrrolidone) (ISP Ashland)
EGDMA: ethylene glycol dimethacrylate (Esstech)
TMPTMA: trimethylolpropane trimethacrylate (Esstech)
TEGDMA: tetraethylene glycol dimethacrylate (Esstech)
mPDMS: mono-n-butyl terminated monomethacryloxypropyl terminated polydimethylsiloxane
(Mₙ=800-1500 g/mol) (Gelest)
Omnirad 403: bis(2,6-dimethoxybenzoyl)-2,4,4-trimethylpentylphosphine oxide
Omnirad 819: bis(2,4,6-trimethylbenzoyl)-phenylphosphineoxide (IGM Resins)
Omnirad 1173: 2-hydroxy-2-methyl-1-phenylpropanone (IGM Resins)
Omnirad 1870: mixture of 70 weight % Omnirad 403 and 30 weight % Omnirad 1173 (IGM Resins)
Norbloc: 2-(2′-hydroxy-5-methacrylyloxyethylphenyl)-2H-benzotriazole (Janssen)
Blue HEMA: 1-amino-4-[3-(4-(2-methacryloyloxy-ethoxy)-6-chlorotriazin-2-ylamino)-4-sulfophenylamino]anthraquinone-2-sulfonic acid, as described in U.S. Pat. No. 5,944,853 phosphoethanolamine, sodium salt
DIW: deionized water
PS: Borate Buffered Packing Solution: 18.52 grams (300 mmol) of boric acid, 3.7 grams (9.7 mmol) of sodium borate decahydrate, and 28 grams (197 mmol) of sodium sulfate were dissolved in enough deionized water to fill a 2-liter volumetric flask.
D3O: 3,7-dimethyl-3-octanol (Vigon)
3E3P: 3-ethyl 3-pentanol
BAGE: Boric Acid Glycerol Ester (molar ratio of boric acid to glycerol was 1:2: 299.3 grams (3.25 mol) of glycerol and 99.8 grams (1.61 mol) of boric acid were dissolved in 1247.4 grams of a 5% (w/w) aqueous ethylenediaminetetraacetic acid solution in a suitable reactor and then heated with stirring to 90-94° C. under mild vacuum (2-6 torr) for 4-5 hours and allowed to cool down to room temperature.
BC: base or back curve plastic mold made of PP, TT, Z, or blends thereof
FC: front curve plastic mold made of PP, TT, Z, or blends thereof
OZ: optical zone of a lens
PP: polypropylene which is the homopolymer of propylene
TT: Tuftec which is a hydrogenated styrene butadiene block copolymer (Asahi Kasei Chemicals)
Z: Zeonor which is a polycycloolefin thermoplastic polymer (Nippon Zeon Co Ltd)
RMM: reactive monomer mixture(s)
CSN: crosslinked substrate network(s)
LED: light emitting diode(s)
rpm: revolutions per minute
m: meter(s)
mm: millimeter(s)
cm: centimeter(s)
micrometer(s)
nm: nanometer(s)
mL: milliliter(s)
mW: milliwatt(s)
kgf: kilogram-force or 9.806 Newtons or 9.802 kg-m/s²
s: second(s)
min: minute(s)
g: gram(s)
kg: kilogram(s)
torr: 1 mm Hg or 133.32 pascals

### FTIR: Fourier Transform Infrared Spectroscopy

24 well plate: CoStar® Tissue culture treated non-pyrogenic polystyrene plates (Corning)

### Crosslinked Substrate Networks (CSN 1-3)

Reactive monomer mixtures (representative of the first reactive composition) were formed by mixing the formulation components with the diluents as listed in Table 1. These formulations were filtered through a 3 μm filter using a heated or unheated stainless steel or glass syringe depending on viscosity and degassed by applying vacuum (about 650 mm Hg) at ambient temperature for about 10 minutes. With a nitrogen gas atmosphere and about 0.5-1.0 percent oxygen gas, 75 μL of the reactive mixture were dosed into the FC. The BC was then placed onto the FC. A pallet containing eight lens mold assemblies was irradiated for about 10 minutes at 60° C. or 70° C. using 435 nm LED lights having intensity of about 6 mW/cm² at the pallet location. The resulting contact lenses were stored as prepared in the dark and protected from any additional exposure to light by for instance wrapping with aluminum foil.

The contact lenses made in CSN 1-3 are crosslinked substrate networks suitable for subsequent grafting reactions, because they contain monoacylphosphine oxide end-groups which function as the second activation source and decompose into radials upon irradiation at 420 nm. The contact lenses made in CSN1 were mechanically released from the molds just prior to the grafting experiments. The contact lenses made in CSN2 were released from the molds by soaking the lenses in 70 percent IPA for 1 hour, followed by soaking two more times in fresh 70 percent IPA for at least 30 minutes, and then in fresh DIW for at least 30 minutes. The contact lenses made in CSN3 were released from the molds by soaking the lenses in DIW heated to 60° C.-70° C. for at least 1 hour. For both contact lenses made in CSN2 and CSN3, the lenses were vacuum dried for 48 hours and stored in a nitrogen filled glovebox before use.

FIG. 1 shows how a typical crosslinked substrate network, in this case CSN1, shrinks in size when suspended in aqueous salt solutions or aqueous salt solutions containing polymerizable components such as monomer and macromers like mPEG500. The shrinkage occurs rapidly over the first five minutes. The lens remains shrunken for an additional 15 to 20 minutes before expanding slowly. As a result, there is a preferred grafting window between about 5 and about 15 minutes, during which time grafting can be best performed on the shrunken crosslinked substrate network lens, resulting in a surface modification of the lens.

TABLE 1
RMMs for Crosslinked Substrate Networks

| | CSN1 | CSN2 | CSN3 |
|---|---|---|---|
| Component | Weight Percent | Weight Percent | Weight Percent |
| mPDMS | 31.09 | 31.00 | 0 |
| SiMAA2 | 28.08 | 28.00 | 0 |
| DMA | 24.07 | 24.00 | 0 |
| HEMA | 6.02 | 5.85 | 95.909 |
| MAA | 0 | 0 | 1.961 |
| PVP K90 | 7.02 | 7.00 | 0 |
| TEGDMA | 1.50 | 1.65 | 0 |
| EGDMA | 0 | 0 | 0.778 |
| TMPTMA | 0 | 0 | 0.091 |
| Norbloc | 2.00 | 2.00 | 0.960 |
| Omnirad 819 | 0.20 | 0.14 | 0.287 |
| Omnirad 1870 | 0 | 0.34 | 0 |
| Blue-HEMA | 0.02 | 0.02 | 0.014 |
| Σ Component | 100 | 100 | 100 |
| Mixture | | | |

Reactive Monomer Mixtures (weight percent)

| | | | |
|---|---|---|---|
| Component Mixture | 77 | 77 | 52 |
| Diluent 3M3P | 23 | 0 | 0 |
| Diluent D3O | 0 | 23 | 0 |
| Diluent BAGE | 0 | 0 | 48 |
| Cure Temperature | 60 | 60 | 70 |
| (° C.) | | | |

### Example 1

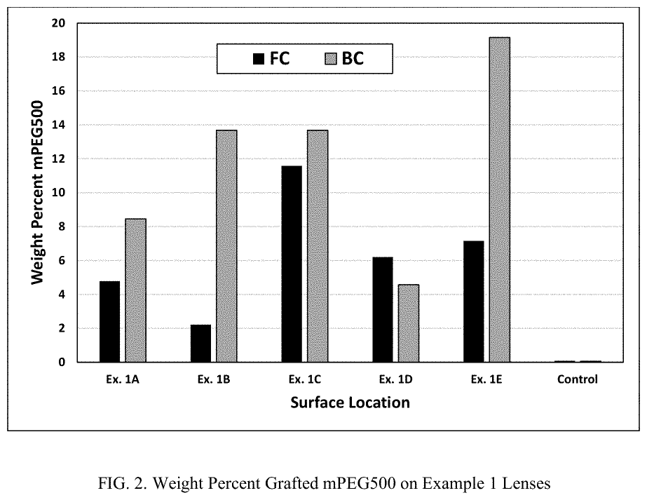

Three individual RMMs were prepared in DIW composed of 20% (w/w) sodium chloride and 5% (w/w) mPEG500 and labeled as RMM 1-3. A control solution was also prepared composed only 5% (w/w) mPEG500 in DIW. As shown in Table 2, these solutions were degassed for 30-60 minutes by application of static vacuum (about 650 torr) immediately before use. For each example, working under yellow lights and preventing premature light exposure, four CSN1 lenses were placed concave up (base curve up/front curve down) in the center wells of a 24 well plate on a shaker located inside a glove box maintain at 30° C. having a nitrogen gas atmosphere. Each well contained 1.5 mL of the RMM or control solution. After an equilibrium time of 12 minutes, the wells were irradiated with 420 nm LED lights having an intensity of 6 mW/cm² at the plate location for 4 minutes. For examples 1C and 1D, the shaker was operational during irradiation as listed in Table 2. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 2, only the salt monomer solutions yield any significant mPEG500 grafting on the front and back surfaces of the lenses under these experimental conditions.

TABLE 2
Experimental Conditions

| | Degas Time | Agitation | |
|---|---|---|---|
| Example | (min) | (rpm) | RMM |
| Ex. 1A | 30 | 0 | 1 |
| Ex. 1B | 60 | 0 | 2 |
| Ex. 1C | 60 | 150 | 2 |
| Ex. 1D | 60 | 225 | 2 |
| Ex. 1E | 60 | 0 | 3 |
| Control | 30 | 0 | 1 |

### Examples 2

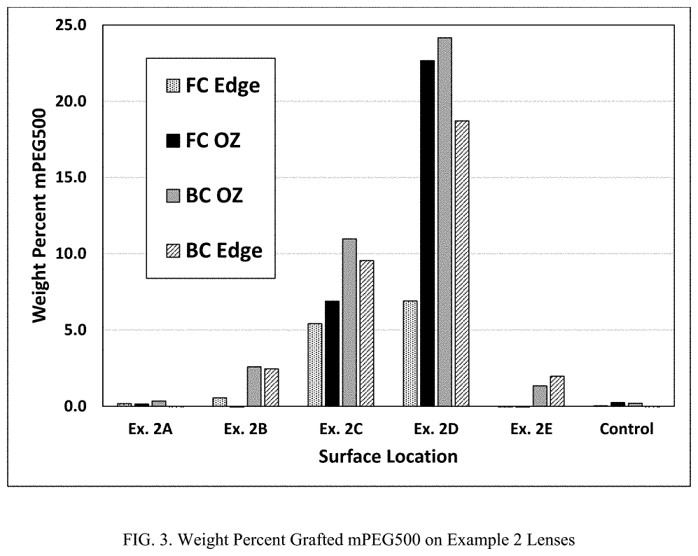

Three individual RMMs were prepared in DIW composed of 18-20% (w/w) sodium chloride and 3-7% (w/w) mPEG500 as listed in Table 3. A control solution was also prepared composed only 5% (w/w) mPEG500 in DIW. These solutions were degassed for 30 minutes by application of static vacuum (about 650 mm Hg) immediately before use. For each example, working under yellow lights and preventing premature light exposure, four CSN1 lenses were placed concave up in the center wells of a 24 well plate on a shaker located inside a glove box maintain at 30° C. having a nitrogen gas atmosphere. Each well contained 1.5 mL of the RMM or control solution. After an equilibrium time of 12 minutes, the wells were irradiated with 420 nm LED lights having an intensity of 6 mW/cm² at the plate location for 3-5 minutes depending on the example. In all experiments, the shaker was operational during irradiation at 120 rpm. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 3, the grafting conditions of examples 2C and 2D yielded the most significant amounts mPEG500 grafting on the front and back surfaces of the lenses including locations in the optical zone and peripheral edge.

TABLE 3
Experimental Conditions

| | Sodium Chloride | mPEG500 | Grafting |
|---|---|---|---|
| | Concentration | Concentration | Time |
| Example | (weight percent) | (weight percent) | (minutes) |
| Ex. 2A | 20 | 5 | 3 |
| Ex. 2B | 20 | 5 | 4 |
| Ex. 2C | 20 | 5 | 5 |
| Ex. 2D | 22 | 3 | 4 |
| Ex. 2E | 18 | 7 | 4 |
| Control | 0 | 5 | 5 |

### Examples 3

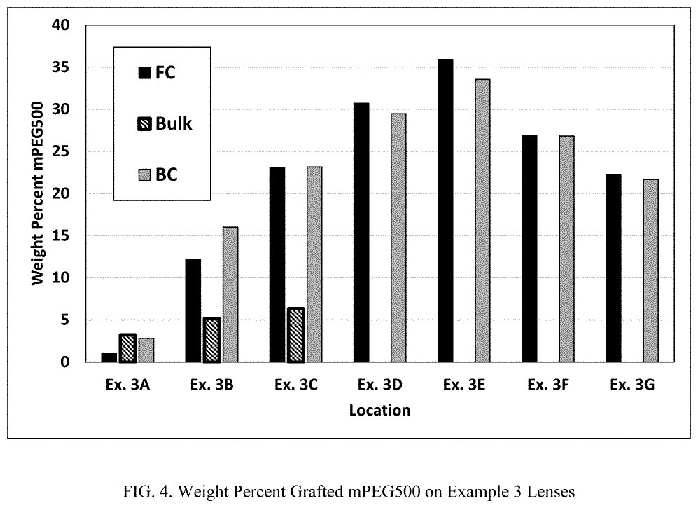

A RMM was prepared in DIW composed of 20% (w/w) sodium chloride and 5% (w/w) mPEG500. These solutions were degassed for 30 minutes by application of static vacuum (about 650 torr) immediately before use. For each example, working under yellow lights and preventing premature light exposure, four CSN1 lenses were placed concave up in the center wells of a 24 well plate on a stand located inside a glove box maintain at 30° C. having a nitrogen gas atmosphere. The stand was configured to allow irradiation from the above and below the plate. Each well contained 1.5 mL of the RMM. After an equilibrium time of 12 minutes, the wells were irradiated with 420 nm LED lights having the intensities and durations as listed in Table 4 depending on the experiment. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 4, the grafting conditions of examples 3C-3G yielded greater than 20 weight percent grafted mPEG500 on the front and back surfaces of the lenses. In examples 3B and 3C, surface concentration of mPEG500 was measured to be about two to three times that of the bulk concentration.

TABLE 4
Experimental Conditions

| | | Top | Bottom |
|---|---|---|---|
| | Grafting | Irradiation | Irradiation |
| | Time | Intensity | Intensity |
| Example | (minutes) | (mW/cm²) | (mW/cm²) |
| Ex. 3A | 1 | 4 | 2 |
| Ex. 3B | 1.5 | 4 | 2 |
| Ex. 3C | 2 | 4 | 2 |
| Ex. 3D | 2.5 | 4 | 2 |
| Ex. 3E | 3 | 4 | 2 |
| Ex. 3F | 2 | 3 | 2 |
| Ex. 3G | 2 | 3 | 1 |

### Examples 4

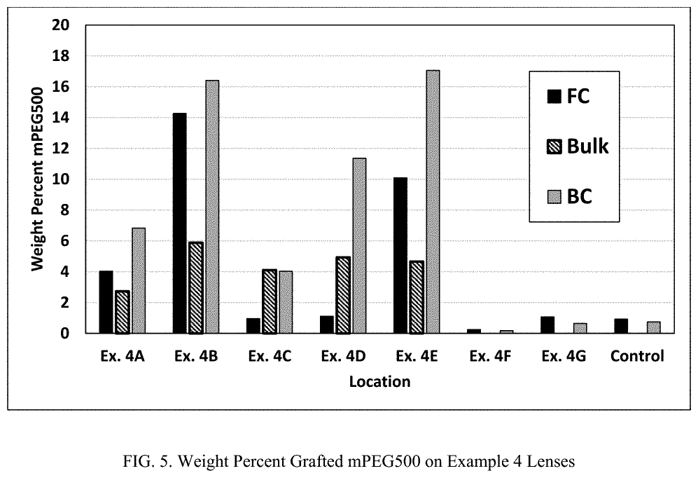

Seven individual RMMs were prepared in DIW composed of 5-25% (w/w) sodium chloride and 2.5-25% (w/w) mPEG500 as listed in Table 5. A control solution was also prepared composed only 5% (w/w) mPEG500 in DIW. These solutions were degassed for 30 minutes by application of static vacuum (about 650 torr) immediately before use. For each example, working under yellow lights and preventing premature light exposure, four CSN1 lenses were placed concave up in the center wells of a 24 well plate on a stand located inside a glove box maintain at 30° C. having a nitrogen gas atmosphere. The stand was configured to allow irradiation from the above and below the plate. Each well contained 1.5 mL of the RMM. After an equilibrium time of 12 minutes, the wells were irradiated with 420 nm LED lights having a top intensity of 4 mW/cm² and a bottom intensity of 2 mW/cm² for 1.5 minutes. After irradiation, the grafted lenses were hydrated with DIW, allowed to equilibrate in DIW for at least 12 hours, and then placed into vials with fresh DIW and autoclaved at 122° C. for 30 minutes. All of the lenses were round except for example 4E in which some lenses were slightly distorted. The concentration of grafted mPEG500 was measured using FTIR. As shown in FIG. 5, the grafting conditions of examples 4B and 4E yielded surfaces with higher concentrations of mPEG500 than those measured in the bulk. It appears that higher versus lower salt concentrations in the RMM favor surface grafting, while the mPEG500 concentration can be too low or too high for effective surface grafting.

TABLE 5
Experimental Conditions

| | Sodium Chloride | mPEG500 |
|---|---|---|
| | Concentration | Concentration |
| Example | (weight percent) | (weight percent) |
| Ex. 4A | 20 | 2.5 |
| Ex. 4B | 20 | 5 |
| Ex. 4C | 20 | 10 |
| Ex. 4D | 20 | 25 |
| Ex. 4E | 25 | 5 |
| Ex. 4F | 10 | 5 |
| Ex. 4G | 5 | 5 |
| Control | 0 | 5 |

### Examples 5

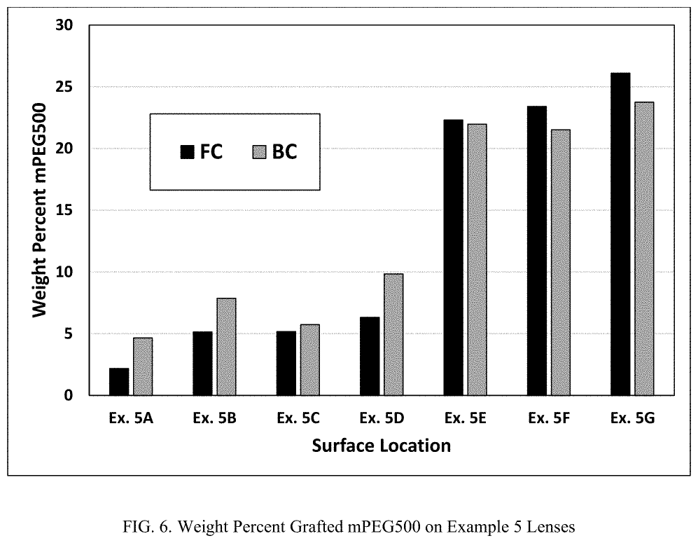

A RMM was prepared in DIW composed of 20% (w/w) sodium chloride and 5% (w/w) mPEG500. These solutions were degassed for 30 minutes by application of static vacuum (about 650 torr) immediately before use. For each example, working under yellow lights and preventing premature light exposure, four CSN1 lenses were placed concave up in the center wells of a 24 well plate on a stand located inside a glove box maintain at 30° C. having a nitrogen gas atmosphere. The stand was configured to allow irradiation from the above and below the plate. Each well contained 1.5 mL of the RMM. After an equilibrium time of 12 minutes, the wells were irradiated with 420 nm LED lights having the intensities as listed in Table 6 depending on the experiment. The irradiation time was held constant at 1.5 minutes. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 6, the grafting conditions of examples 5E-5G yielded greater than 20 weight percent grafted mPEG500 on the front and back surfaces of the lenses. It appears than surface grafting is increased by using double sided, differential cure conditions, especially when the differential is moderate (two times higher on top than bottom). Examples 5A-5D were round lenses while examples 5E-5G were slightly distorted.

TABLE 6
Experimental Conditions

| | Top Irradiation | Bottom Irradiation |
|---|---|---|
| Example | Intensity (mW/cm²) | Intensity (mW/cm²) |
| Ex. 5A | 5 | 1 |
| Ex. 5B | 4 | 1 |
| Ex. 5C | 3 | 1 |
| Ex. 5D | 2 | 1 |
| Ex. 5E | 4 | 2 |
| Ex. 5F | 3 | 2 |
| Ex. 5G | 4 | 2 |

### Examples 6

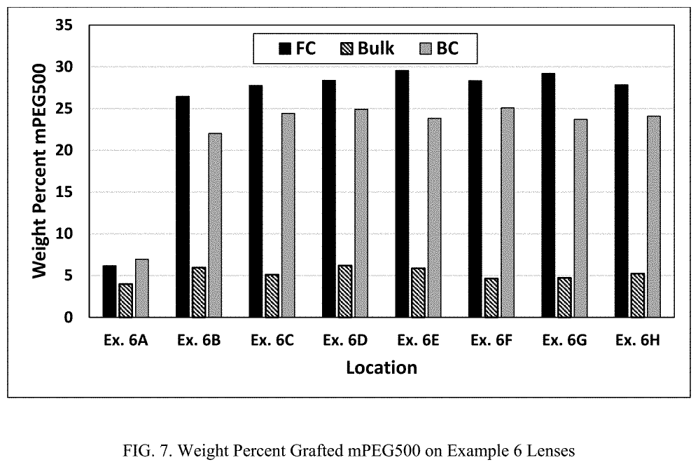

A RMM was prepared in DIW composed of 20% (w/w) sodium chloride and 5% (w/w) mPEG500. These solutions were degassed for 30 minutes by application of static vacuum (about 650 torr) immediately before use. For each example, working under yellow lights and preventing premature light exposure, four CSN1 lenses were placed concave up in the center wells of a 24 well plate on a stand located inside a glove box maintain at 30° C. having a nitrogen gas atmosphere. The stand was configured to allow irradiation from the above and below the plate. Each well contained 1.5 mL of the RMM. After various equilibrium times as listed in Table 7, the wells were irradiated with 420 nm LED lights having a top intensity of 4 mW/cm² and a bottom intensity of 2 mW/cm² for 1.5 minutes. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 7, the grafting conditions of examples 6B-6H yielded greater than 20 weight percent grafted mPEG500 on the front and back surfaces of the lenses. Meanwhile, only examples 6A and 6B produced substantially round lenses; all other lenses were distorted to some extent. As a result, the grafting conditions of example 6B appear to be optimal for mPEG500 surface grafting onto CSN1.

TABLE 7
Experimental Conditions

| Example | Equilibration Time (minutes) |
|---|---|
| Ex. 6A | 14 |
| Ex. 6B | 12 |
| Ex. 6C | 10 |
| Ex. 6D | 8 |
| Ex. 6E | 7 |
| Ex. 6F | 6 |
| Ex. 6G | 5 |
| Ex. 6H | 4 |

### Examples 7

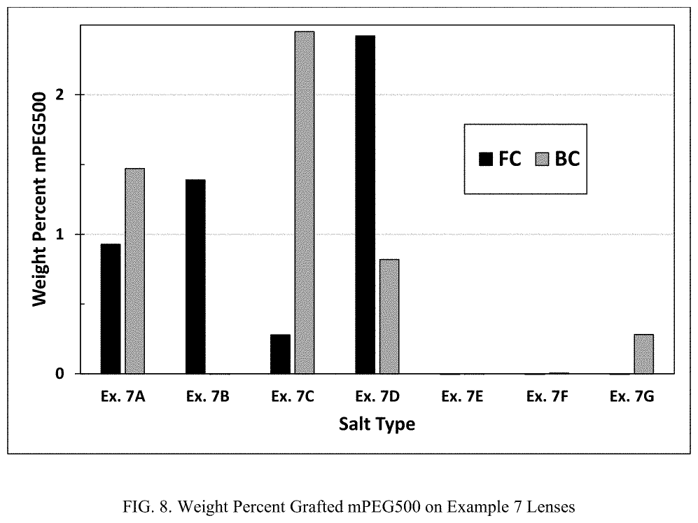

As shown in Table 8, seven individual RMMs were prepared in DIW composed of 15% (w/w) salt and 5% (w/w) mPEG500. These solutions were degassed for 30 minutes by application of static vacuum (about 650 torr) immediately before use. For each example, working under yellow lights and preventing premature light exposure, four CSN1 lenses were placed concave up in the center wells of a 24 well plate on a stand located inside a glove box maintain at 30° C. having a nitrogen gas atmosphere. The stand was configured to allow irradiation from the above and below the plate. Each well contained 1.5 mL of the RMM. After equilibrating for 12 minutes, the wells were irradiated with 420 nm LED lights having a top intensity of 4 mW/cm² and a bottom intensity of 2 mW/cm² for 2 minutes. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 8, the grafting conditions of examples 7A-7D were successful to varying degrees. All of the grafted lenses were round.

TABLE 8
Experimental Conditions

| | Salt Composition and Concentration |
|---|---|
| Example | (weight percent) |
| Ex. 7A | Sodium chloride (15) |
| Ex. 7B | Potassium chloride (15) |
| Ex. 7C | Sodium carbonate (15) |
| Ex. 7D | Magnesium chloride (15) |
| Ex. 7E | Calcium chloride (15) |
| Ex. 7F | Magnesium nitrate (15) |
| Ex. 7G | Iron (II) chloride (15) |

### Examples 8

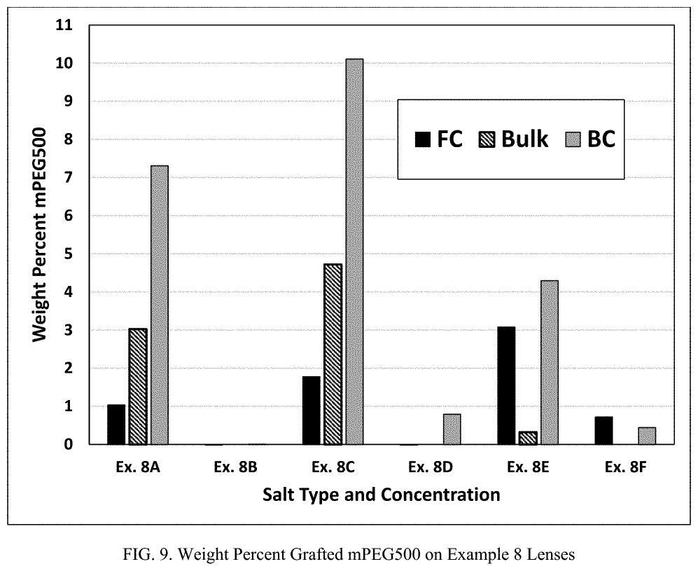

As shown in Table 9, seven individual RMMs were prepared in DIW composed of various salts and concentrations and 5% (w/w) mPEG500. These solutions were degassed for 30 minutes by application of static vacuum (about 650 torr) immediately before use. For each example, working under yellow lights and preventing premature light exposure, four CSN1 lenses were placed concave up in the center wells of a 24 well plate on a stand located inside a glove box maintain at 30° C. having a nitrogen gas atmosphere. The stand was configured to allow irradiation from the above and below the plate. Each well contained 1.5 mL of the RMM. After equilibrating for 6 minutes, the wells were irradiated with 420 nm LED lights having a top intensity of 4 mW/cm² and a bottom intensity of 2 mW/cm² for 2 minutes. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 9, the grafting conditions of examples 8A, 8C, and 8E were successful and favored surface grafting over bulk grafting. All of the grafted lenses were round.

TABLE 9
Experimental Conditions

| | Salt Composition and Concentration |
|---|---|
| Example | (weight percent) |
| Ex. 8A | Sodium chloride (20) |
| Ex. 8B | Potassium chloride (20) |
| Ex. 8C | Sodium bromide (40) |
| Ex. 8D | Sodium carbonate (15) |
| Ex. 8E | Calcium chloride (40) |
| Ex. 8F | Magnesium nitrate (36) |

### Examples 9

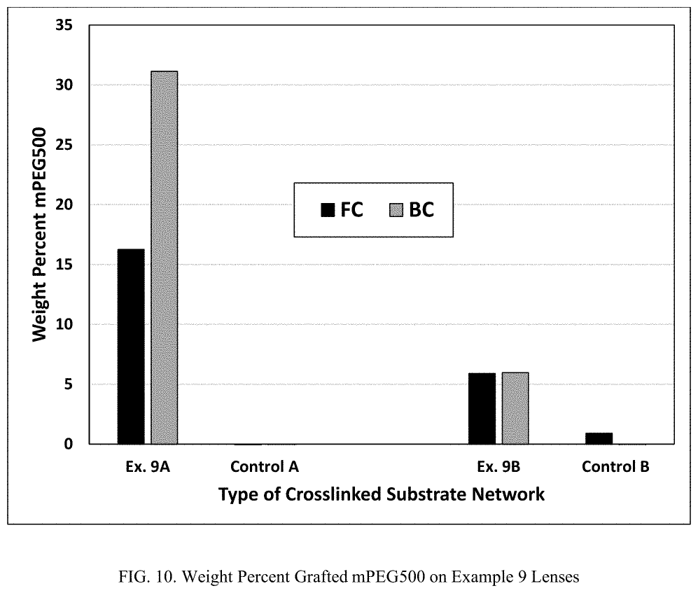

A RMM was prepared in DIW composed of 20% (w/w) sodium chloride and 5% (w/w) mPEG500. A control solution (A or B) was also prepared composed only 5% (w/w) mPEG500 in DIW. These solutions were degassed for 30 minutes by application of static vacuum (about 650 torr) immediately before use. For each example, working under yellow lights and preventing premature light exposure, either four CSN1 lenses or four CSN2 lenses as listed in Table 10 were placed concave up in the center wells of a 24 well plate on a stand located inside a glove box maintain at 35° C. having a nitrogen gas atmosphere. The stand was configured to allow irradiation from the above and below the plate. Each well contained 1.5 mL of the RMM. After equilibrating for 7 minutes, the wells were irradiated with 420 nm LED lights having a top intensity of 4 mW/cm² and a bottom intensity of 2 mW/cm² for 5 minutes. After irradiation, the grafted lenses were hydrated with DIW, allowed to equilibrate in DIW for at least 12 hours, and then placed into vials with fresh DIW and autoclaved at 122° C. for 30 minutes. The concentration of grafted mPEG500 was measured using FTIR. As shown in FIG. 10, mPEG500 was grafted onto CSN1 and CSN2. However, under these conditions, more mPEG500 was grafted onto CSN1 than CSN2. Very little grafting occurred with the control solutions.

TABLE 10
Crosslinked Substrate Networks

| Examples | CSN |
|---|---|
| Ex. 9A | CSN1 |
| Control A | CSN1 |
| Ex. 9B | CSN2 |
| Control B | CSN2 |

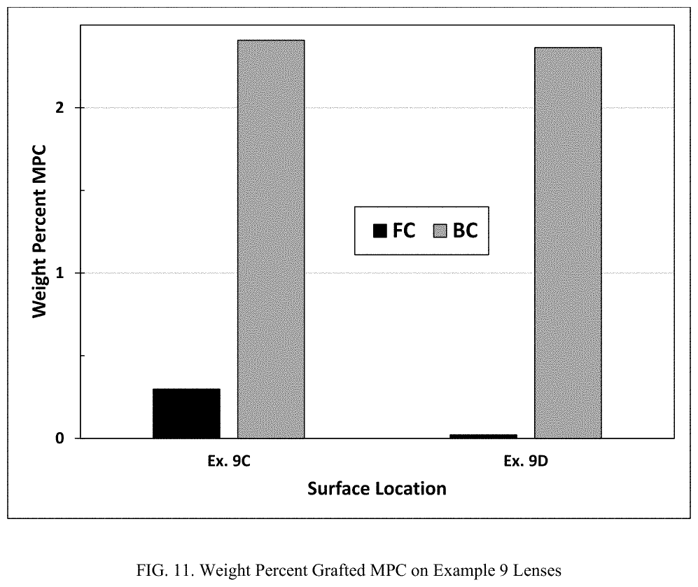

Examples 9A and 9B were repeated except that the RMM was composed of 20% (w/w) sodium chloride and 5% (w/w) MPC. Example 9C used CSN1 and example 9D used CSN2. As shown in FIG. 11, MPC was grafted onto CSN1 and CSN2, but mostly on the base curve side under these conditions.

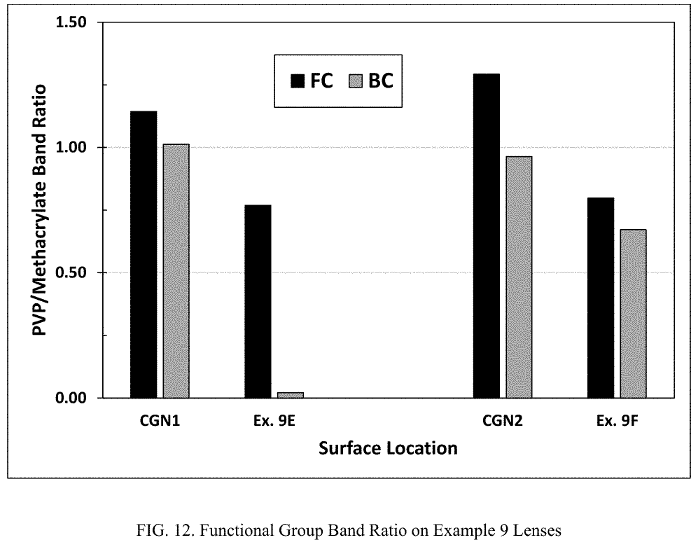

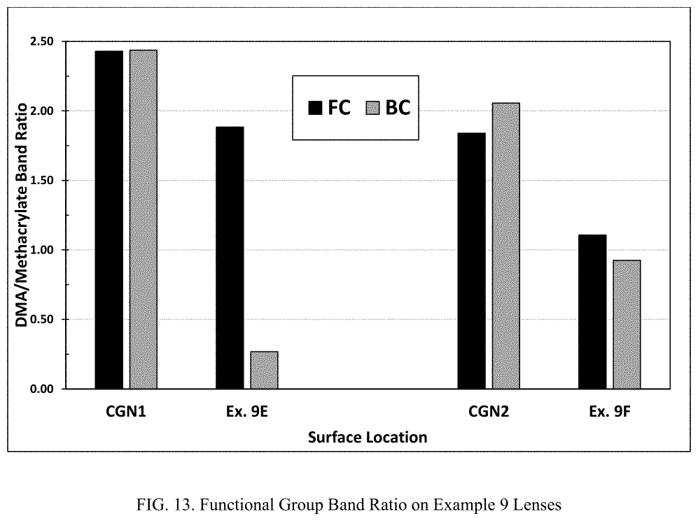

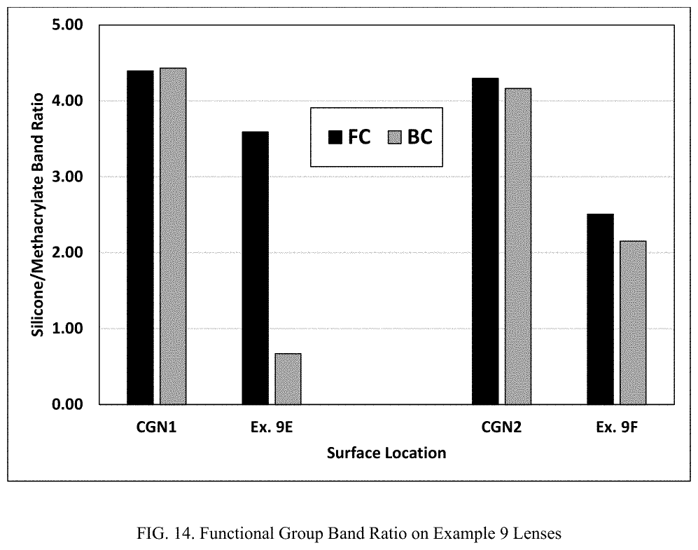

Examples 9A and 9B were repeated except that the RMM was composed of 20% (w/w) sodium chloride and 5% (w/w) HEMA. Example 9E used CSN1 and example 9F used CSN2. In this case, without a calibration curve built from HEMA standards, since grafted HEMA contributes far more to the methacrylate FTIR absorption band than the PVP, DMA, or silicone signals, it was possible to use reductions in those band ratios as indirect evidence of successful HEMA grafting. In addition to diluting the PVP, DMA, and silicone signals, grafted HEMA contributes to the denominator of the band ratios, thereby further reducing those band ratios. As shown in FIGS. 12-14, examples 9E and 9F showed reductions in PVP/methacrylate, DMA/methacrylate, and silicone/methacrylate band ratios as compared to the CSNs, consistent with HEMA grafting.

### Examples 10

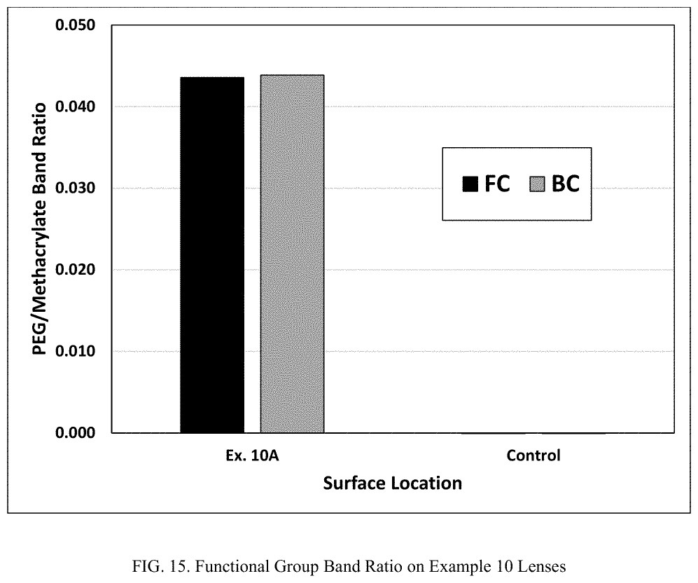

Example 10A: A RMM was prepared in DIW composed of 20% (w/w) sodium chloride and 5% (w/w) mPEG500. A control solution was also prepared composed only 5% (w/w) mPEG500 in DIW. These solutions were degassed for 30 minutes by application of static vacuum (about 650 torr) immediately before use. For each example, working under yellow lights and preventing premature light exposure, four CSN3 lenses were placed concave up in the center wells of a 24 well plate on a stand located inside a glove box maintain at 35° C. having a nitrogen gas atmosphere. The stand was configured to allow irradiation from the above and below the plate. Each well contained 1.5 mL of the RMM. After equilibrating for 7 minutes, the wells were irradiated with 420 nm LED lights having a top intensity of 4 mW/cm² and a bottom intensity of 2 mW/cm² for 5 minutes. After irradiation, the grafted lenses were hydrated with DIW, allowed to equilibrate in DIW for at least 12 hours, and then placed into vials with fresh DIW and autoclaved at 122° C. for 30 minutes. As shown in FIG. 15, using methods similar to those used for HEMA grafting, it was possible to use the band ratio of PEG to methacrylate to detect PEG grafting on CSN3. No PEG grafting was measured with the control solution.

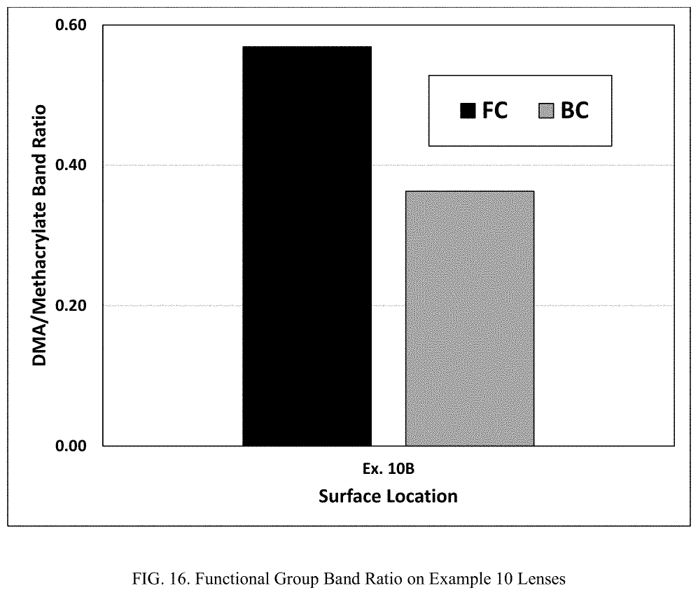

Example 10B: Example 10A was repeated but the RMM was composed of 20% (w/w) sodium chloride and 5% (w/w) DMA. As shown in FIG. 16, using methods similar to those used for HEMA grafting, it was possible to use the band ratio of DMA to methacrylate to detect low levels of DMA grafting on CSN3.

### Examples 11

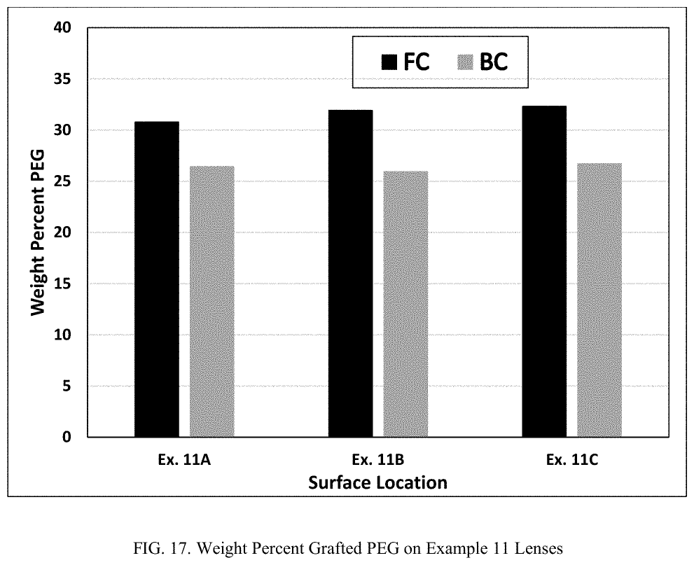

The RMM used in Example 11 was prepared in DIW composed of 20% (w/w) sodium chloride and 5% (w/w) mPEG500. These solutions were degassed for 30 minutes at 50 mbar using a rotary evaporator contained in a nitrogen filled glove box. After degassing, the RMM was capped and transported to a second nitrogen filled glove box to prepare the grafting experiments in Examples 11. For each example, working under yellow lights and preventing premature light exposure, four CSN1 lenses were placed concave up (base curve up/front curve down) in the center wells of a 24 well plate on a shaker located inside a glove box maintain at 30° C. having a nitrogen gas atmosphere. Each well contained 1.5 mL of the RMM. At the start of a 6 minute equilibration, the glove box oxygen concentration was measured. After equilibration, the glove box oxygen concentration was measured for a second time and the wells were irradiated with 420 nm LED lights having a top intensity of 4 mW/cm² and a bottom intensity of 2 mW/cm² for 1.5 minutes. For Example 11A, the amount of time the post-irradiated lenses were kept inside the nitrogen glove box was equal to the amount of time left outside the nitrogen glove box before submerging the 24 well plate in DIW. For Examples 11B and 11C, the 15 second quench times were either increased in the nitrogen glove box (Example 11B to 105 seconds) or outside the nitrogen glove box (Example 11C to 105 seconds) before submerging the 24 well plate in DIW. After submerging the 24 well plate in DIW, the lenses were transferred to fresh DIW, allowed to equilibrate in DIW for at least 12 hours, placed into vials with packing solution, and autoclaved at 121° C. for 30 minutes. The concentration of grafted PEG was measured using FTIR. As shown in FIG. 17, the BC lagged the FC with the BC and FC averages approximately 25 and 30 wt %, respectively. Quench times, regardless of extra time either inside or outside the nitrogen glove box post-irradiation had little influence on the amount of PEG grafted.

TABLE 11
Experimental Conditions

| | | | [O2] at | [O2] at |
|---|---|---|---|---|
| | Quench Time | Quench Time | start of | start of |
| | (sec in | (sec outside | Equilibration | Grafting |
| Example | glove box) | glove box) | (mg/L) | (mg/L) |
| Ex. 11A | 15 | 15 | 0.23 | 0.00 |
| Ex. 11B | 105 | 15 | 0.08 | 0.01 |
| Ex. 11C | 15 | 105 | 0.09 | 0.00 |

### Examples 12

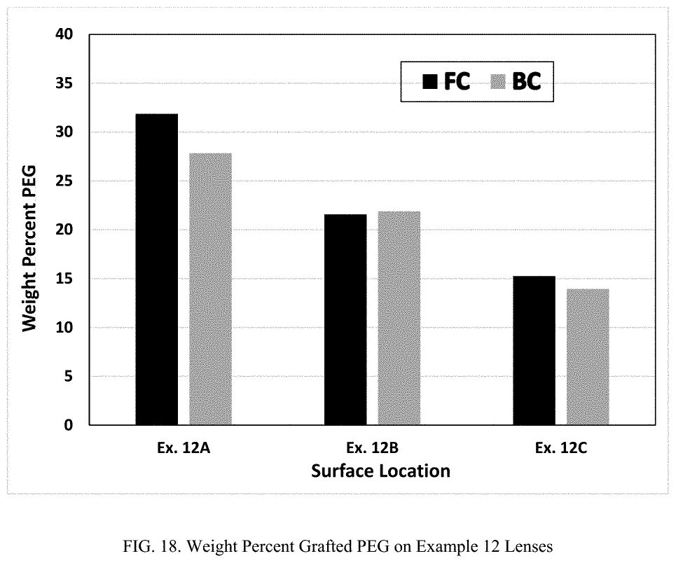

The RMM used in Example 12 was prepared in DIW composed of 20% (w/w) sodium chloride and 5% (w/w) mPEG500. These solutions were degassed for 30 minutes at 50 mbar using a rotary evaporator contained in a nitrogen filled glove box. After degassing, the RMM was capped and transported to a second nitrogen filled glove box to prepare the grafting experiments in Examples 12. For each example, working under yellow lights and preventing premature light exposure, four CSN1 lenses were placed concave up (base curve up/front curve down) in the center wells of a 24 well plate on a shaker located inside a glove box maintain at 30° C. having a nitrogen gas atmosphere. Each well contained 1.5 mL of the RMM. At the start of a 6 minute equilibration, the glove box oxygen concentration was measured. After equilibration, the glove box oxygen concentration was measured for a second time. The wells were irradiated with 420 nm LED lights having a top and bottom intensity of 4 and 2 mW/cm², respectively, for half of the total irradiation time, followed by flipping the top and intensity to be 2 and 4 mW/cm², respectively, for the second half of the total irradiation time. For Example 12A, 12B, and 12C, the total time of the 2 step cure process was 90, 60 and 30 seconds, respectively. After irradiation, the 24 well plate was taken outside the nitrogen glove box and submerged in DIW. After submerging the 24 well plate in DIW, the lenses were transferred to fresh DIW, allowed to equilibrate in DIW for at least 12 hours, placed into vials with packing solution, and autoclaved at 121° C. for 30 minutes. The concentration of grafted mPEG500 was measured using FTIR. As shown in FIG. 18, the wt % PEG lowers as a function of time. At 90 seconds total time, BC lags FC (ca. 28 vs 32 wt % PEG). Although at lower total times (60 and 30 seconds total time), the approximate wt % PEG on both the FC and BC approach equivalency as well as producing less total PEG grafted on both curves.

TABLE 12
Experimental Conditions

| | | | | [O2] at | [O2] at |
|---|---|---|---|---|---|
| | Step 1 | Step 2 | Total | start of | start of |
| | Time | Time | Time | Equilibration | Grafting |
| Example | (s) | (s) | (s) | (mg/L) | (mg/L) |
| Ex. 12A | 45 | 45 | 90 | 0.05 | 0.00 |
| Ex. 12B | 60 | 30 | 60 | 0.07 | 0.00 |
| Ex. 12C | 15 | 15 | 30 | 0.01 | 0.00 |

1. A process for making an ophthalmic device, the process comprising:
(a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker;
(b) subjecting the first reactive composition to a first activation step such that the first reactive composition polymerizes therein to form a crosslinked substrate network containing a covalently bound activatable free radical initiator;
(c) contacting the crosslinked substrate network with a grafting composition containing a shrinking agent and one or more ethylenically unsaturated compounds; and
(d) activating the covalently bound activatable free radical initiator of the crosslinked substrate network such that the grafting composition polymerizes therein with the crosslinked substrate network.

2. The process of claim 1 wherein the shrinking agent is an ammonium salt, a metal salt, or a mixture of two or more thereof.

3. The process of claim 1 wherein the shrinking agent is an ammonium salt, an alkali metal salt, an alkali earth metal salt, or a mixture of two or more thereof.

4. The process of claim 1 wherein the shrinking agent is sodium chloride, sodium carbonate, potassium chloride, or a mixture of two or more thereof.

5. The process of claim 1 wherein the ethylenically unsaturated compounds of the grafting composition are more concentrated at the crosslinked substrate network's surface than at its core.

6. The process of claim 1 wherein the one or more ethylenically unsaturated compounds of step (a) comprise one or more polymerizable groups independently selected from: (meth)acrylate, (meth)acrylamide, styryl, vinyl, N-vinyl lactam, N-vinylamide, O-vinylether, O-vinylcarbonate, O-vinylcarbamate, C₂₋₁₂ alkenyl, C₂₋₁₂ alkenylphenyl, C₂₋₁₂ alkenylnaphthyl, and C₂₋₆ alkenylphenyl-C₁₋₆ alkyl.

7. The process of claim 1 wherein the one or more ethylenically unsaturated compounds of step (c) comprise one or more polymerizable groups independently selected from: (meth)acrylate, (meth)acrylamide, styryl, vinyl, N-vinyl lactam, N-vinylamide, O-vinylether, O-vinylcarbonate, O-vinylcarbamate, C₂₋₁₂ alkenyl, C₂₋₁₂ alkenylphenyl, C₂₋₁₂ alkenylnaphthyl, and C₂₋₆ alkenylphenyl-C₁₋₆ alkyl.

8. The process of claim 1 wherein the polymerization initiator is a bisacylphosphine oxide, a bisacylphosphane oxide, a di-azo compound, a di-peroxide compound, an azo-bis(monoacylphosphine oxide), an azo-bi s(monoacylphosphane oxide), a peroxy-bis(monoacylphosphine oxide), a peroxy-bi s(monoacylphosphane oxide), an azo-bis(alpha-hydroxy ketone), a peroxy-bis(alpha-hydroxy ketone), an azo-bis(1,2-diketone), a peroxy-bis(1,2-diketone), a germanium based compound, tert-butyl 7-methyl-7-(tert-butylazo)peroxyoctanoate, or combinations thereof.

9. The process of claim 1 wherein the polymerization initiator is a bisacylphosphine oxide or a bis(acyl)phosphane oxide.

10. The process of claim 1 wherein the ophthalmic device is in the form of a hydrogel and wherein the first reactive composition contains one or more silicone-containing components and the grafting composition contains one or more hydrophilic reactive components.

11. The process of claim 1 wherein the first reactive composition, the grafting composition, or both the first reactive composition and the grafting composition contain one or more additives selected from UV absorbers, HEV light absorbers, photochromic compounds, pharmaceutical compounds, nutraceutical compounds, antimicrobial compounds, reactive tints, pigments, copolymerizable dyes, non-polymerizable dyes, release agents, wetting agents, and release agents.

12. The process of claim 1 wherein the ophthalmic device is selected from the group consisting of a contact lens, an intraocular lens, a punctal plug and an ocular insert.

13. An ophthalmic device made by the process of claim 1.
